(19) United States
(12) Patent Application Publication
(10) Pub. No.: US 2026/0057659 A1
(43) Pub. Date: Feb. 26, 2026

(54) IMAGE FEATURE MAP ENCODING/DECODING METHOD, DEVICE AND RECORDING MEDIUM BASED ON LATENT EXPRESSION DISTRIBUTION EXPANSION

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: JooYoung LEE, Daejeon (KR); Se Yoon JEONG, Daejeon (KR); Youn Hee KIM, Daejeon (KR); Jung Won KANG, Daejeon (KR); Hui Yong KIM, Yongin-si (KR); Seung Hwan JANG, Yongin-si (KR); Hye Won JEONG, Yongin-si (KR); Dal Hong LIM, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 19/262,457

(22) Filed: Jul. 8, 2025

(30) Foreign Application Priority Data
Jul. 8, 2024 (KR) 10-2024-0089953
Oct. 24, 2024 (KR) 10-2024-0146596
Jul. 7, 2025 (KR) 10-2025-0090963

(51) Int. Cl. G06V 10/82; G06V 10/77

(52) U.S. Cl. CPC G06V 10/82; G06V 10/7715

(57) ABSTRACT

An image feature map encoding/decoding method, device and recording medium based on the latent representation distribution expansion of the present disclosure may include obtaining a reconstructed feature map latent representation by decoding a feature map latent representation obtained by encoding a feature map from a bitstream, and obtaining a reconstructed feature map by decoding the reconstructed feature map latent representation, wherein the reconstructed feature map may be obtained by performing distribution expansion based on a distribution expansion parameter obtained from the bitstream.

### CROSS-REFERENCE TO RELATED APPLICATION

This application claims the profits of the preceding application date and the priority to Korean Application No. 10-2024-0089953 filed on Jul. 8, 2024, claims the profits of the preceding application date and the priority to Korean Application No. 10-2024-0146596 filed on Oct. 24, 2024 and claims the profits of the preceding application date and the priority to Korean Application No. 10-2025-0090963 filed on Jul. 7, 2025, wherein the contents of the applications are incorporated herein by reference in their entirety.

### TECHNICAL FIELD

The present disclosure relates to the technical fields of a method, a device and a recording medium for encoding/decoding a feature map extracted through an artificial neural network.

### BACKGROUND ART

As machine tasks have been widely used in a variety of devices including mobile devices as well as large servers, a feature map extraction means and a task execution means are increasingly located within a different device without being located within the same device.

When image feature maps are encoded/decoded by using an artificial neural network, the distribution of reconstructed images or reconstructed feature maps may be different from the distribution of original images or original feature maps, and a technology for modifying this is required.

### DISCLOSURE

### Technical Problem

When the distribution of reconstructed images or reconstructed feature maps is different from the distribution of original images or original feature maps, it may cause a decline in machine vision performance. Therefore, the present disclosure aims to resolve this by correcting the distribution of the restored feature map or restored latent representation.

### Technical Solution

An image feature map encoding/decoding method, device and recording medium based on the latent representation distribution expansion of the present disclosure may include obtaining a reconstructed feature map latent representation by decoding a feature map latent representation obtained by encoding a feature map from a bitstream and obtaining a reconstructed feature map by decoding the reconstructed feature map latent representation, wherein the reconstructed feature map may be obtained by performing distribution expansion based on a distribution expansion parameter obtained from the bitstream and the distribution expansion parameter may include a distribution expansion degree parameter.

In an image feature map encoding/decoding method, device and recording medium based on the latent representation distribution expansion of the present disclosure, obtaining the reconstructed feature map may include obtaining an intermediate reconstructed feature map by decoding the reconstructed feature map latent representation and obtaining the reconstructed feature map by performing distribution expansion based on the distribution expansion parameter on the intermediate reconstructed feature map.

In an image feature map encoding/decoding method, device and recording medium based on the latent representation distribution expansion of the present disclosure, obtaining the reconstructed feature map may include obtaining a distribution-expanded reconstructed feature map latent representation by performing distribution expansion based on the distribution expansion parameter on the reconstructed feature map latent representation and obtaining the reconstructed feature map by decoding the distribution-expanded reconstructed feature map latent representation.

In an image feature map encoding/decoding method, device and recording medium based on the latent representation distribution expansion of the present disclosure, the distribution expansion parameter may additionally use at least one of the average of the feature map latent representation and the standard deviation of the feature map latent representation in addition to the distribution expansion degree parameter.

In an image feature map encoding/decoding method, device and recording medium based on the latent representation distribution expansion of the present disclosure, the distribution expansion degree parameter may have a different value for each channel of the reconstructed feature map latent representation.

In an image feature map encoding/decoding method, device and recording medium based on the latent representation distribution expansion of the present disclosure, the average of the feature map latent representation and the standard deviation of the feature map latent representation may be obtained by using the channel length of the feature map latent representation.

In an image feature map encoding/decoding method, device and recording medium based on the latent representation distribution expansion of the present disclosure, the distribution expansion parameter may be determined for each frame I.

In an image feature map encoding/decoding method, device and recording medium based on the latent representation distribution expansion of the present disclosure, the distribution expansion parameter may be determined for each number of specific frames.

In an image feature map encoding/decoding method, device and recording medium based on the latent representation distribution expansion of the present disclosure, the learning of the distribution expansion degree parameter may be performed simultaneously with the learning of a feature map reconstruction means in which obtaining a reconstructed feature map by decoding the reconstructed feature map latent representation is performed.

In an image feature map encoding/decoding method, device and recording medium based on the latent representation distribution expansion of the present disclosure, the learning of the distribution expansion degree parameter may be performed after the learning of a feature map reconstruction means is completed in which obtaining a reconstructed feature map by decoding the reconstructed feature map latent representation is performed.

In an image feature map encoding/decoding method, device and recording medium based on the latent representation distribution expansion of the present disclosure, the obtaining of the reconstructed feature map latent representation may be performed by using a standard video compression codec or a neural network-based video compression codec.

In an image feature map encoding/decoding method, device and recording medium based on the latent representation distribution expansion of the present disclosure, in response to the obtaining of the reconstructed feature map latent representation being performed by using the standard video compression codec, the obtaining of the reconstructed feature map latent representation may be obtained by performing a latent representation channel rearrangement method.

In an image feature map encoding/decoding method, device and recording medium based on the latent representation distribution expansion of the present disclosure, the latent representation channel rearrangement method may use at least one of a channel spatial arrangement, a channel temporal arrangement or a channel spatiotemporal arrangement.

In an image feature map encoding/decoding method, device and recording medium based on the latent representation distribution expansion of the present disclosure, the number of horizontal channels and the number of vertical channels used for the channel spatial arrangement may be obtained from the bitstream.

In an image feature map encoding/decoding method, device and recording medium based on the latent representation distribution expansion of the present disclosure, the distribution expansion parameter may additionally use at least one of the average of the feature map and the standard deviation of the feature map in addition to the distribution expansion degree parameter.

In an image feature map encoding/decoding method, device and recording medium based on the latent representation distribution expansion of the present disclosure, the learning of the distribution expansion degree parameter may be performed by using the distribution of the output signal or intermediate feature map of an artificial neural network and the distribution of the input signal of the artificial neural network.

### Technical Effect

By using the distribution expansion technology of the present disclosure, it is possible to minimize a decline in machine vision performance and improve machine vision performance.

### BRIEF DESCRIPTION OF DRAWINGS

FIG. 1 illustrates an example of a machine task result for object detection and classification using Fast R-CNN, which is one of the artificial neural networks.

FIG. 2 illustrates an example in which a multi-layer feature map is extracted to perform a machine task.

FIG. 3 illustrates the structure of Mask R-CNN, which is an artificial neural network model frequently used for object segmentation.

FIG. 4 illustrates an example of multi-layer feature map Pk extracted through the FPN of Mask R-CNN.

FIG. 5 illustrates an embodiment of a multi-layer feature map.

FIG. 6 illustrates an example in which a means for extracting a feature map exists in a mobile device, while a means for performing a specific task such as object segmentation, disparity map estimation or image reconstruction exists in a cloud server.

FIG. 7 illustrates a neural network-based image compression process.

FIG. 8 illustrates a process in which a neural network-based multi-layer feature map compression (or encoding/decoding) is performed.

FIG. 9 illustrates an embodiment of a neural network-based feature map encoding method that supports variable bit rate encoding.

FIG. 10 illustrates an embodiment of an image feature map encoding and decoding process.

FIG. 11 illustrates an embodiment of an image feature map encoding and decoding process.

FIG. 12A illustrates an example of the structure of a feature map latent representation extraction means.

FIG. 12B illustrates an example of the structure of a feature map latent representation extraction means.

FIG. 13 illustrates an example of the configuration of feature map latent representation extraction blocks used in FIG. 12A.

FIGS. 14 and 15 illustrate the detailed structure of a neural network block used in FIGS. 12A and 12B.

FIG. 16 illustrates an example of the structure of a feature map reconstruction means.

FIG. 17 illustrates an example of the configuration of neural network blocks for additional information and feature map reconstruction blocks used in FIG. 16.

FIG. 18A illustrates another example of a feature map reconstruction means.

FIG. 18B illustrates another example of a feature map reconstruction means.

FIG. 19 illustrates an example of the influence of a feature map latent representation extraction means and a feature map reconstruction means on the feature map value distribution.

FIG. 20 illustrates an embodiment of an encoding and decoding process for an image feature map including a means for reconstructed feature map latent representation distribution expansion.

FIG. 21 illustrates an example of a feature map encoding process.

FIG. 22 illustrates an example of a feature map decoding process.

FIG. 23 illustrates an example of a feature map latent representation extraction means.

FIG. 24 illustrates an example of a feature map reconstruction means.

FIG. 25 illustrates an example of a process for learning a feature map latent representation extraction means and a feature map reconstruction means.

FIGS. 26 and 27 illustrate an example of syntax structures for a parameter for a reconstructed feature map latent representation distribution expansion means.

FIG. 28 illustrates an example of semantics for a parameter for a reconstructed feature map latent representation distribution expansion means.

FIG. 29 illustrates an embodiment of a fused feature scaling process.

FIG. 30 illustrates methods for encoding and decoding a reconstructed feature map latent representation distribution expansion parameter.

FIG. 31 illustrates an example of a feature map configuration.

FIG. 32 illustrates an example of a spatially arranged feature map.

FIG. 33 illustrates an example of a temporally arranged feature map.

FIG. 34 illustrates an example of a spatiotemporally arranged feature map.

FIG. 35 illustrates an example of neural network-based fused latent representation entropy encoding.

FIG. 36 illustrates an example in which a latent representation group is spatially partitioned into a checkerboard pattern.

FIG. 37 illustrates an example of a feature map latent representation probability distribution estimation means.

FIG. 38 illustrates an example in which narrowing distribution is compensated through the first part of an artificial neural network-based machine task model and the second part of a machine task model.

FIG. 39 illustrates an example of a machine task model.

### MODE FOR INVENTION

The present invention may be variously changed, and may have various embodiments, and specific embodiments will be described in detail below with reference to the attached drawings. However, it should be understood that those embodiments are not intended to limit the present invention to specific disclosure forms, and that they include all changes, equivalents or modifications included in the spirit and scope of the present invention. In the drawings, similar reference numerals are used to designate the same or similar functions in various aspects. The shapes, sizes, etc. of components in the drawings may be exaggerated to make the description clear. Detailed descriptions of the following exemplary embodiments will be made with reference to the attached drawings illustrating specific embodiments. These embodiments are described so that those having ordinary knowledge in the technical field to which the present disclosure pertains can easily practice the embodiments. It should be noted that the various embodiments are different from each other, but do not need to be mutually exclusive of each other. For example, specific shapes, structures, and characteristics described here may be implemented as other embodiments without departing from the spirit and scope of the embodiments in relation to an embodiment. Further, it should be understood that the locations or arrangement of individual components in each disclosed embodiment can be changed without departing from the spirit and scope of the embodiments. Therefore, the accompanying detailed description is not intended to restrict the scope of the disclosure, and the scope of the exemplary embodiments is limited only by the accompanying claims, along with equivalents thereof, as long as they are appropriately described.

Terms such as “first” and “second” may be used to describe various components, but the components are not restricted by the terms. The terms are used only to distinguish one component from other components. For example, a first component may be named a second component without departing from the scope of the present specification and likewise, a second component may be named a first component. The terms “and/or” may include combinations of a plurality of related described items or any of a plurality of related described items.

It will be understood that when a component in the present disclosure is referred to as being “connected” or “coupled” to another component, it may be directly connected or coupled to such another component, but another component also may exist in the middle. On the other hand, it will be understood that when a component is referred to as being “directly connected or coupled”, another component does not exist in the middle.

As construction units shown in an embodiment of the present disclosure are independently shown to represent different characteristic functions, it does not mean that each construction unit is composed in a construction unit of separate hardware or one software. In other words, construction units are included by being arranged as a construction unit for convenience of a description, and at least two of the construction units may be integrated into one construction unit, or one construction unit may be divided into a plurality of construction units to perform a functions, and the integrated embodiment and the separated embodiment of each construction unit are also included in the scope of the right of the present disclosure as long as they do not depart from the essence of the present disclosure.

The terms used in the present disclosure are merely used to describe specific embodiments, and are not intended to limit the present disclosure. A singular expression includes a plural expression unless the context clearly indicates otherwise. In the present disclosure, it should be understood that terms such as “include” or “have” are merely intended to indicate that features, numbers, steps, operations, components, parts described herein or combinations thereof are present, and are not intended to exclude the possibility in advance that one or more other features, numbers, steps, operations, components, parts or combinations thereof are present or added. In other words, a description of “including” a specific configuration does not exclude a configuration other than a corresponding configuration, and means that an additional configuration may be included in the scope of the technical idea of the present disclosure or the embodiment of the present disclosure.

Some components of the present disclosure are not an essential component for performing an essential function in the present disclosure, but may be merely an optional component for improving performance. The present disclosure may be implemented by including only construction units essential for implementing the essence of the present disclosure excluding components used only for performance improvement, and a structure including only essential components excluding optional components used only for performance improvement is also included in the scope of the right of the present disclosure.

Hereinafter, the embodiments of the present disclosure will be described in detail below by referring to drawings. In describing the embodiments of the present disclosure, when it is determined that a specific description for related known configurations or functions may obscure the gist of the present disclosure, that detailed description is omitted, and the same reference numerals are used for the same components on drawings and a repeated description for the same components is omitted.

An artificial neural network (ANN) is increasingly utilized in machine tasks such as a variety of machine vision tasks such as object classification, object recognition, object detection, object segmentation, object tracking, etc. or such as a variety of image processing tasks including super-resolution, frame-interpolation, etc.

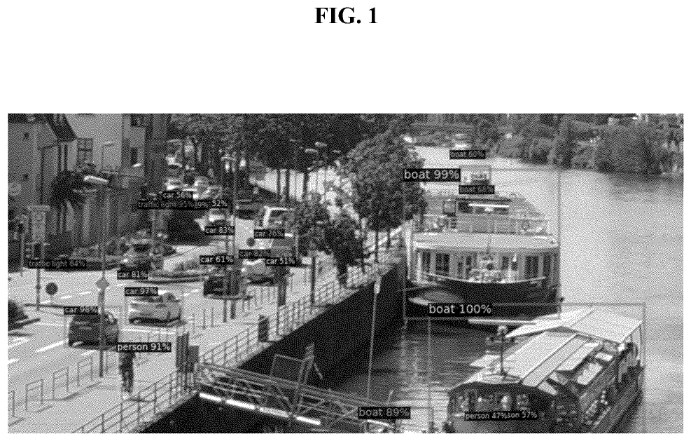

FIG. 1 illustrates an example of a machine task result for object detection and classification using Fast R-CNN, which is one of the artificial neural networks.

Referring to FIG. 1, recognized objects in FIG. 1 may be classified into vehicles, ships, people, traffic signals, etc., respectively, and each region may be composed of quadrangles, and probability information (or accuracy) regarding whether a corresponding region matches a classified object may be included. Here, a quadrangle is an example of a region form, and a region form may include a circle, a polygon, etc. In addition, segmentation within a region may cause the range of a region to match the range of an object as much as possible.

An artificial neural network model that performs a machine task typically consists of a feature map extraction means that extracts a feature from input data or an input image and a task execution means that actually performs a specific machine task based on an extracted feature. In this case, when an input has an image form, ‘extracted feature’ may be typically referred to as a feature map. While the present disclosure describes the invention by using an expression ‘feature map’, the present disclosure may be applied equally to a feature, not a map form.

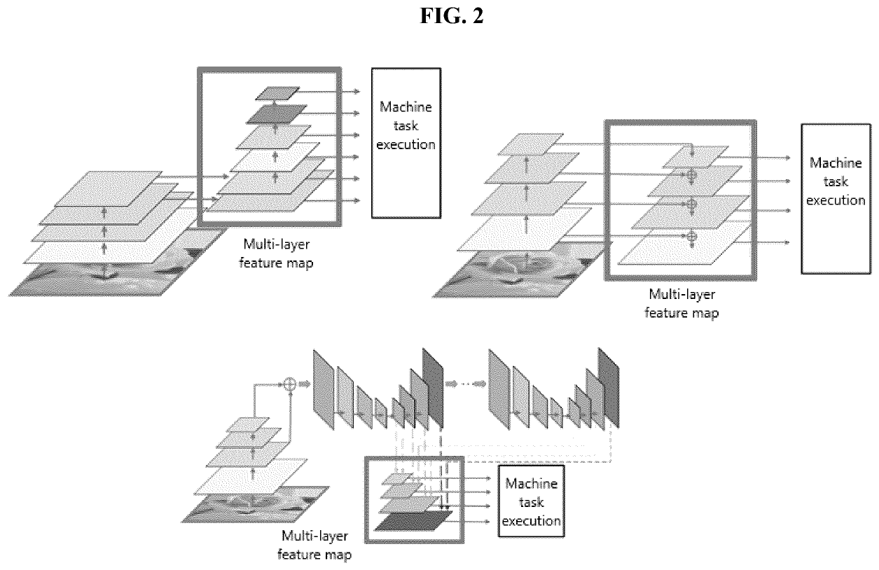

FIG. 2 illustrates an example in which a multi-layer feature map is extracted to perform a machine task.

The present disclosure may be applied to a pyramid-structured feature map or a multi-layer feature map. A multi-layer feature map may have a pyramid structure in which feature maps with different resolution are formed into multiple layers. As an example, as a feature map belongs to a higher layer (or as a layer index increases), the resolution of a feature map may decrease, and as a feature map belongs to a lower layer (or as a layer index decreases), the resolution of a feature map may increase. As another example, as a feature map belongs to a higher layer (or as a layer index increases), the resolution of a feature map may increase, and as a feature map belongs to a lower layer (or as a layer index decreases), the resolution of a feature map may decrease. In addition, feature maps within the same layer may have the same resolution.

The layer information of each layer within a multi-layer feature map (e.g., a layer index, layer resolution, etc.) may be included in feature map information and delivered in performing a machine task.

The present disclosure may relate to a compression (or encoding/decoding) method, device and recording medium for such a multi-layer feature map.

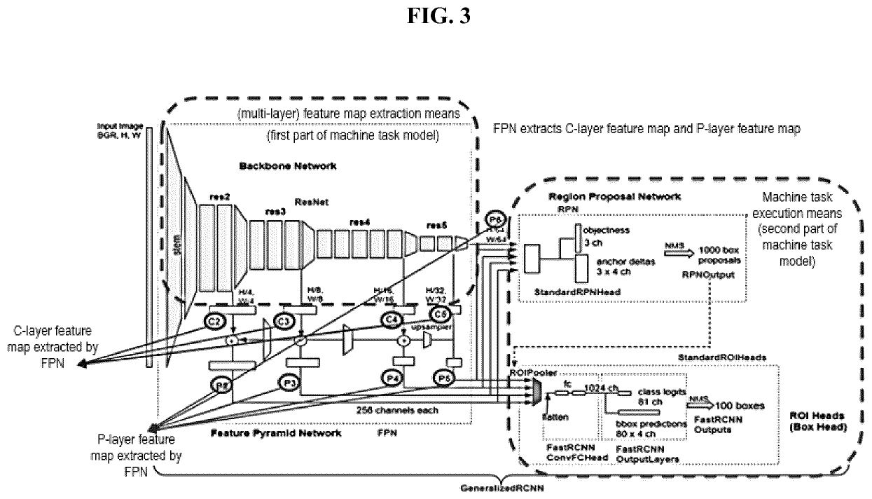

FIG. 3 illustrates the structure of Mask R-CNN, which is an artificial neural network model frequently used for object segmentation.

In the Mask R-CNN structure of FIG. 3, a feature pyramid network (FPN) may be used as a multi-layer feature map extraction means, and a region proposal network (RPN) and a region of interest (ROI) heads may be used as a machine task execution means.

A feature pyramid network (FPN) is an example of extracting a multi-layer feature map, and a C-layer feature map and a P-layer feature map may be extracted by a FPN. Here, both a C-layer feature map and a P-layer feature map may be the multi-layer feature map of the present disclosure.

Hereinafter, the present disclosure will describe the invention by using the P-layer feature map of FIG. 3. However, it is merely for convenience of a description, but the description of the present disclosure may also be applied equally to the C-layer feature map of FIG. 3 or other forms of multi-layer feature maps.

When an input is an image, the form of a feature map may be represented as a two-dimensional arrangement of width×height, and since the feature map of one layer typically consists of multiple channels, the feature map of each layer may be expressed as a three-dimensional arrangement having a size equal to width×height x number of channels.

In other words, when the feature map of layer k is Fₖ, Fₖ may be represented as three-dimensional arrangement Fₖ[x][y][c] consisting of extracted feature values. Here, x and y may represent the horizontal and vertical positions of a feature value, respectively, and c may represent a channel index. For example, multi-layer feature maps Ck or multi-layer feature maps Pk extracted from a FPN may be referred to as multi-layer feature map Fₖ of the present disclosure, and may be expressed as three-dimensional arrangement Fk[x][y][c].

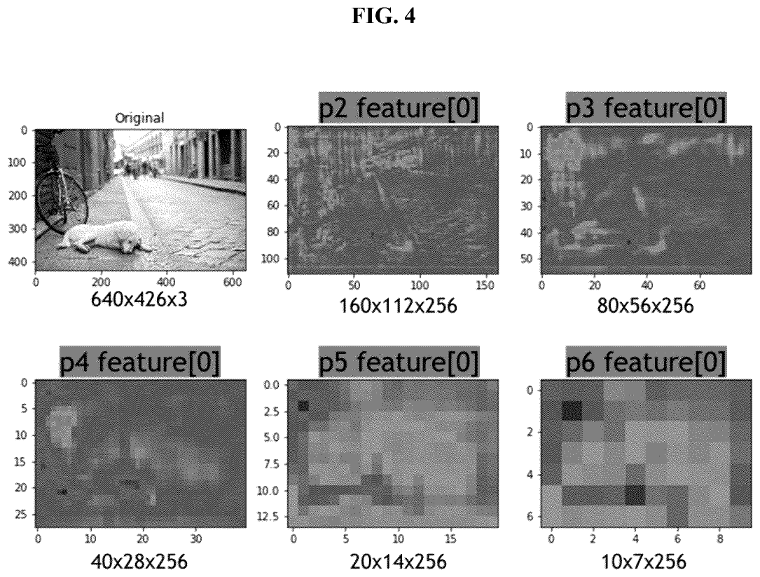

FIG. 4 illustrates an example of multi-layer feature map Pk extracted through the FPN of Mask R-CNN.

Referring to FIG. 4, the example of the first channel may be confirmed from P-layer feature map Pk which is a multi-layer feature map extracted through the FPN of the Mask R-CNN of FIG. 3. In this case, layer index k may be 2, 3, 4, 5 or 6. Alternatively, layer index k may have a value greater than 6.

In other words, the feature map of each layer may consist of 256 channels in a FPN, and in FIG. 4, only a feature map corresponding to the first channel among the feature maps of each layer may be shown as an example. For reference, in a FPN, as a layer gets deeper (as a layer index increases), the width and height of a feature map may become increasingly smaller than the size (resolution) of an input image.

In a FPN, the feature maps of five layers from P₂ to P₆ are extracted and used. However, when a feature map is encoded, all of the five extracted feature maps may be encoded, and after encoding only the feature maps of four layers from P₂ to P₅, P₆ may be reconstructed based on decoded P₅.

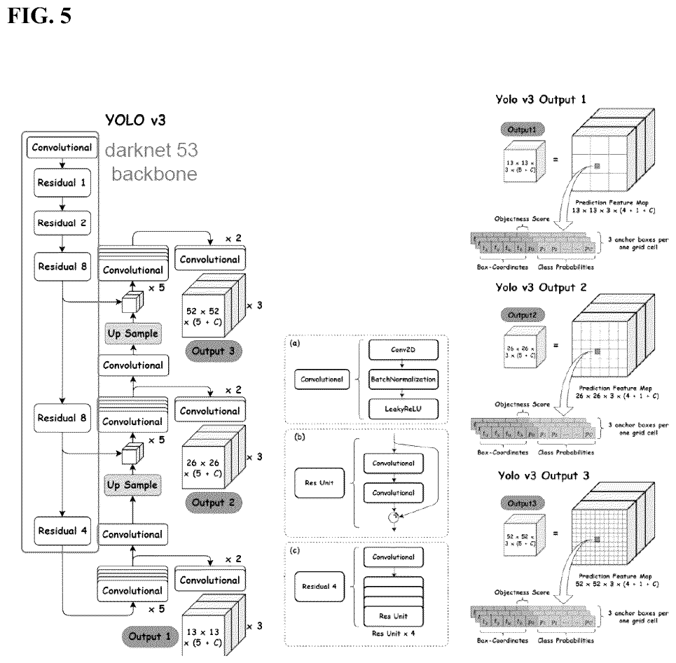

FIG. 5 illustrates an embodiment of a multi-layer feature map.

Referring to FIG. 5, even in a model for a machine task such as YOLO v3, a multi-layer feature map consisting of three layers (Output 1, Output 2, Output 3) may be extracted as shown in FIG. 5 and used for machine task execution in a similar manner to a P-layer feature map.

Specifically, the multi-layer feature map may be a case where a pyramid structure similar to a FPN is used with darknet 53 as a multi-layer feature map extraction means within YOLO v3.

When an extracted feature map is encoded, as shown in a FPN, all feature maps of the three layers may be encoded or a feature map with lower resolution may be reconstructed and used from a reconstructed feature map without encoding.

As machine tasks have been widely used in a variety of devices including mobile devices as well as large servers, a feature map extraction means and a machine task execution means are increasingly located within a different device without being located within the same device.

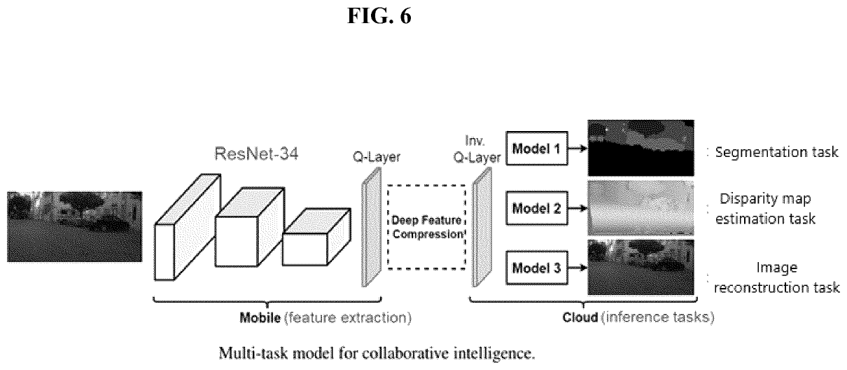

FIG. 6 illustrates an example in which a means for extracting a feature map exists in a mobile device, while a means for performing a specific task such as object segmentation, disparity map estimation or image reconstruction exists in a cloud server.

A feature map extracted from a mobile device may be transmitted to a server, a task may be performed on a server based on a transmitted feature map, and a result of performing a task may be transmitted back to a mobile device.

As in this case, when a feature map extraction means and a task execution means are separated, an extracted feature map must be transmitted to a task execution means, and a feature map encoding method for minimizing task execution performance degradation simultaneously with minimizing the amount of data of a feature map to be transmitted or stored may be required.

As another example, even when a feature map extraction means and a task execution means are located in one device, an extracted feature map may be stored in a storage device and then, may be utilized later in a task execution means, and in this case, a feature map compression (or encoding/decoding) method as above may also be required.

In the present disclosure, ‘image’ may refer to various types of images such as computer graphics, a holographic image, a feature map image extracted through a neural network, a ultrasound image, etc. as well as a natural image obtained through a camera.

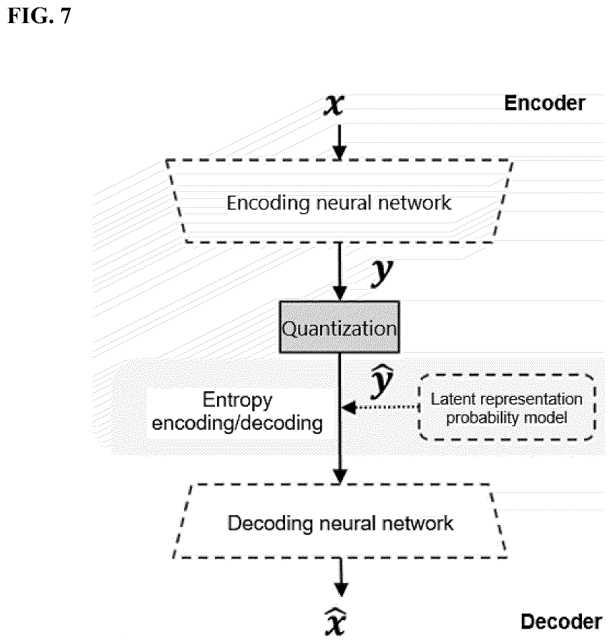

FIG. 7 illustrates a neural network-based image compression process.

The core component of a neural network-based image compression (or encoding/decoding) method may include an encoding neural network, a decoding neural network, quantization, a latent representation probability model and entropy encoding and decoding, and a process of performing image compression (or encoding/decoding) is described as shown in 1) to 6) together with FIG. 7.

1) An encoder may transform image x to be encoded (i.e., an input image) into latent representation y through an encoding neural network.

The latent representation may refer to one of a latent vector, a latent representation and a latent feature map.

2) Each component yᵢ of latent representation y may be quantized.

3) The quantized latent representation \hat{ }y may be transmitted to an decoder in the form of a bitstream through learnable latent representation probability model P_{(\hat{ }y)}(\hat{ }y)-based entropy encoding.

4) A bitstream transmitted from an encoder may be reconstructed into \hat{ }y through the same latent representation probability model-based entropy decoding as in an encoder.

5) A decoding neural network may reconstruct an image by using \hat{ }y as an input. In the present disclosure, a reconstructed image may be represented as \hat{ }x.

6) The neural network parameter of a core component may be learned through a loss function and a backpropagation algorithm.

In FIG. 7, a block whose borders are indicated with dotted lines may refer to a learnable parameter or neural network.

Since a multi-layer feature map is composed of multiple feature maps with different spatial resolution, an encoding method different from when encoding a natural image may be required, and in the present disclosure, a neural network-based image compression method when an input image is multi-layer feature map {Fₖ}_{k=1, . . . , L} (L is the number of layers) is described particularly as a neural network-based multi-layer feature map compression method. As an example, multi-layer feature map {Fₖ}_{k=1, . . . L} may refer to the feature map of a layer with higher spatial resolution as k decreases. As another example, multi-layer feature map {Fₖ}_{k=1 . . . , L} may refer to the feature map of a layer with lower spatial resolution as k decreases.

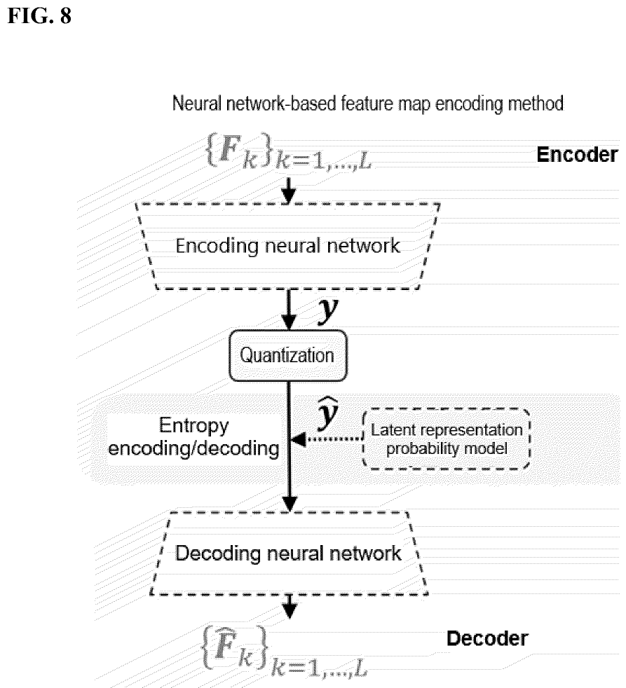

FIG. 8 illustrates a process in which a neural network-based multi-layer feature map compression (or encoding/decoding) is performed.

The core component of a neural network-based multi-layer feature map compression (or encoding/decoding) method is also an encoding neural network, a decoding neural network, quantization, a latent representation probability model and entropy encoding and decoding, and a process of performing neural network-based multi-layer feature map compression (or encoding/decoding) is described through FIG. 8 and 1) to 6).

1) An encoder may transform multi-layer feature map {Fₖ}_{k=1, . . . , L} to be encoded into latent representation y through an encoding neural network.

2) Each component yᵢ of latent representation y may be quantized.

3) The quantized latent representation \hat{ }y may be transmitted to a decoder in the form of a bitstream through learnable latent representation probability model P_{(\hat{ }y)}(\hat{ }y)-based entropy encoding.

4) A bitstream transmitted from an encoder may be reconstructed into \hat{ }y through the same latent representation probability model-based entropy decoding as in an encoder.

5) A decoding neural network may reconstruct a multi-layer feature map by using \hat{ }y as an input. A multi-layer feature map reconstructed in the present disclosure may be indicated as {\hat{ }Fₖ}_{k=1, . . . , L}.

6) The parameter of a core component may be learned through a loss function and a backpropagation algorithm.

In FIG. 8, a block whose borders are indicated with dotted lines may refer to a learnable parameter or neural network.

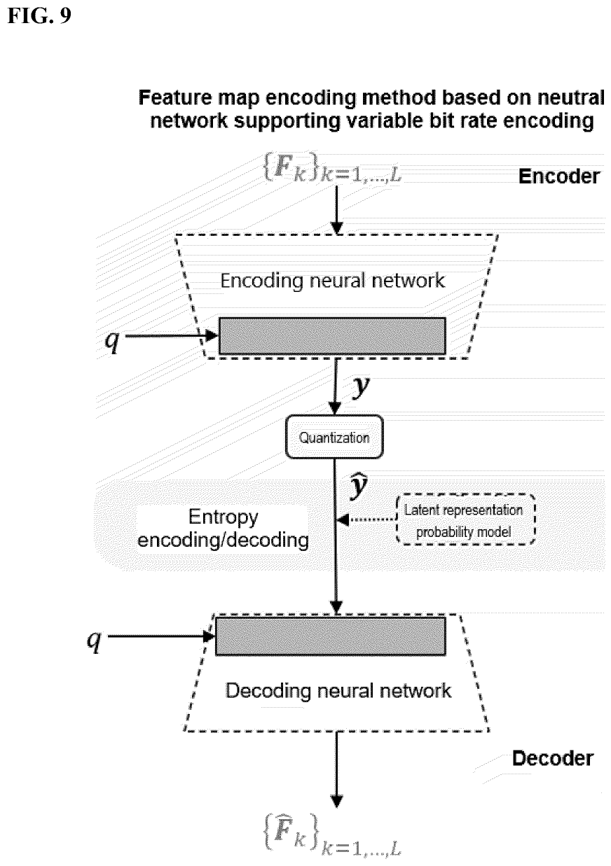

FIG. 9 illustrates an embodiment of a neural network-based feature map encoding method that supports variable bit rate encoding.

A gain unit (GU) and an inverse gain unit (IGU) used to support variable bit rate encoding in neural network-based image compression may also be applied similarly to neural network-based multi-layer feature map encoding as shown in FIG. 9.

A gain unit and an inverse gain unit may be positioned at the end of an encoding neural network and the start of a decoding neural network as shown in FIG. 9.

A gain unit may be a process of scaling each channel of an input feature map by using one of the Q gain vectors (GV) {v_{q}}_{(q=1, . . . , Q)} for variable bit rate encoding.

Integer q>0 represents a bit rate level, and Q is the number of bit rate levels to be used for variable bit rate encoding.

If T is an intermediate latent representation immediately before a gain unit, a scaling process in a gain unit may be as follows.

$$y [ c ] [ h ] [ w ] = τ [ c ] [ h ] [ w ] \times {v}_{q} [ c ]$$

c=1, . . . , c, h=1, . . . , H, w=1, . . . , W are the channel, vertical and horizontal indexes of latent representation T, respectively, and in general, the length of a gain vector may be the same as C.

An inverse gain unit may also be a process of scaling each channel of an input feature map by using one of the inverse gain vectors (IGV) {u_{q}}_{(q=1, . . . , Q)} corresponding to a gain vector.

If η is an intermediate latent representation after an inverse gain unit, a scaling process in an inverse gain unit may be as follows.

$$η [ c ] [ h ] [ w ] = \hat{} y [ c ] [ h ] [ w ] \times {u}_{q} [ c ]$$

c=1, . . . , c, h=1, . . . , H, w=1, . . . , W are the channel, vertical and horizontal indexes of quantized latent representation \hat{ }y, respectively, and in general, the length of an inverse gain vector may be the same as C.

The component values of a gain vector and inverse gain vector pair (v_{q}, u_{q}) may be optimized through learning to satisfy bit rate constraints corresponding to given bit rate level q.

Consequently, the bit rate and reconstruction image quality of an image to be currently encoded may be determined according to bit rate level q given to a gain unit and an inverse gain unit.

The neural network-based multi-layer feature map compression is performed through neural networks composed of learnable parameters, and these neural networks are referred to as a neural network-based multi-layer feature map compression models and the learning of these neural networks may be performed through a backpropagation algorithm that updates the weights of a neural network and a parameter in a direction that minimizes a specific loss function calculated from learning data.

When learning a neural network-based multi-layer feature map compression model, a rate-distortion optimization method or a rate-performance optimization method may be used.

A rate-distortion optimization method is to perform learning to simultaneously minimize distortion between an input multi-layer feature map and a reconstructed multi-layer feature map and the bit rate of a bitstream transmitted from an encoder to a decoder.

A rate-performance optimization method is to perform learning to simultaneously minimize machine task execution performance performed through a reconstructed multi-layer feature map and the bit rate of a bitstream transmitted from an encoder to a decoder.

A distortion loss function used in a neural network-based multi-layer feature map compression model may be used by weighted summing the mean square error (MSE) or the multi-scale structural similarity index measure (MS-SSIM) between input multi-layer feature map {Fₖ}_{k=1, . . . , L} and reconstructed multi-layer feature map {\hat{ }Fₖ}_{k=1, . . . , L} on weight wₖ according to each layer as shown in Equation 1.

A bit rate may be approximated by cross-entropy between an actual latent representation and the probability distribution of latent representations estimated by a latent representation probability model as shown in Equation 2.

Machine task loss function L_{P} means the performance of a machine task performed from a compressed and reconstructed multi-layer feature map, and may be calculated through a comparison between the inference results of a correct label and a machine task.

In this case, a classification loss function, a bounding box loss function, a mask loss function, etc. may be used according to the type of a machine task.

Loss function L_{RD} for rate-distortion optimization may be expressed as in Equation 3, and constant λ is used to determine a rate between distortion loss function L_{P} and cross-entropy-based loss function L_{R}, and a desired reconstruction level and bit rate may be determined for the output of a learned model according to λ. (Generally, as λ is larger, a reconstruction level is higher.)

Loss function L_{RP} for rate-distortion optimization may be expressed as in Equation 4, and constant λ is used to determine a rate between performance loss function L_{P} and cross-entropy-based loss function L_{R}, and a desired reconstruction level and bit rate may be determined for the output of a learned model according to λ. (Generally, as λ is larger, machine task performance is higher.)

$${L}_{D} = {E}_{x ∼ {p}_{x}} ( {\sum }_{k = 1 , … , L} {w}_{k} \times D ( {F}_{k} , {\hat{F}}_{k} ) ) , D ( \cdot , \cdot ) is a distortion function such as MSE or MS - SSIM \qquad Equation 1$$

$${L}_{R} = {E}_{x ∼ {p}_{x}} ( - log {p}_{\hat{y}} ( \hat{y} ) ) \qquad Equation 2$$

$$L = {L}_{R} + λ \times {L}_{D} \qquad Equation 3$$

$$L = {L}_{R} + λ \times {L}_{P} \qquad Equation 4$$

A typical machine task model, as described in FIG. 3, consists of a feature map extraction means and a machine task execution means, which may be referred to as the first part of a machine task model and the second part of a machine task model, respectively. In addition, as described in FIG. 6, a machine task model may be divided into two parts and performed in a different device, thereby enabling task partitioning.

Input signal I may have various forms such as an image, a voice, a character string, etc., and machine task result p may be an image, a voice, a character string or machine task performance, etc.

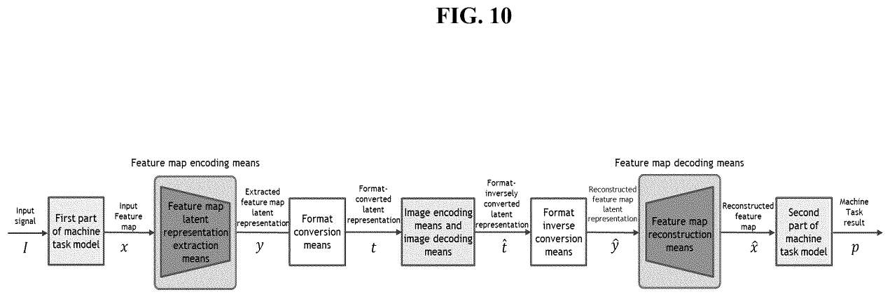

FIG. 10 illustrates an embodiment of an image feature map encoding and decoding process.

1) An encoder may extract feature map latent representation y from an input feature map through a feature map latent representation extraction means.

A feature map may be a single-layer feature map or a multi-layer feature map, and a feature map latent representation may feature a single-layer feature map.

A feature map encoding means may include a feature map latent representation extraction means. A feature map encoding means may optionally further include the process of temporal resolution sampling before a feature map latent representation extraction means. A feature map latent representation extraction means may be composed of artificial neural networks.

A feature map latent representation may refer to one of a latent vector, a latent representation and a latent feature map.

2) Extracted feature map latent representation y may be converted into format-converted latent representation t through a format conversion means, and then may be encoded through an image encoding means to generate a bitstream. Afterwards, when an encoded format-converted latent representation is decoded through an image decoding means, format-inversely converted latent representation \hat{ }t may be generated. Afterwards, in order to ensure that reconstructed feature map latent representation \hat{ }y has a format such as y, a format-inversely converted latent representation may generate reconstructed feature map latent representation \hat{ }y through a format inverse conversion means.

In this case, as an example, an image encoding means and an image decoding means may use a conventional standard video compression codec such as HEVC or VVC or a neural network-based image encoding and decoding means.

In this case, as an example, when a neural network-based codec is used as an image encoding means and an image decoding means, a format conversion means and a format inverse conversion means may be omitted.

3) Reconstructed feature map latent representation \hat{ }y may be reconstructed to a feature map through a feature map decoding means.

A feature map decoding means may include a feature map reconstruction means. When a temporal resolution sampling process is performed before a feature map latent representation extraction means in a feature map encoding means, a feature map decoding means may further include a temporal resolution resampling process after a feature map reconstruction means. A feature map reconstruction means may be composed of artificial neural networks.

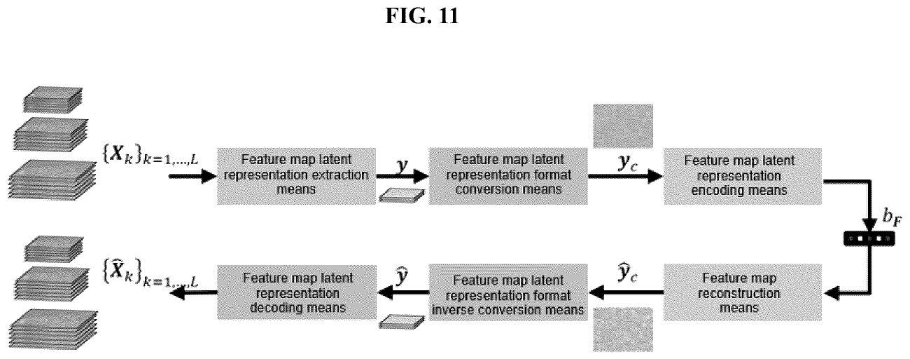

FIG. 11 illustrates an embodiment of an image feature map encoding and decoding process.

An image feature map has multiple channels, and in particular, a multi-layer feature map is composed of multi-layer feature maps, so it may have a very high dimension compared to general images/videos.

As an embodiment, an input image feature map encoding method may include 1) a feature map latent representation extraction means, 2) a feature map latent representation format conversion means and 3) a feature map latent representation encoding means.

A general process of encoding an input image feature map may be described through FIG. 11 and processes 1) to 3) below. In the input image feature map {Xₖ}_{(k=1, . . . , L)} Of FIG. 11, if L=1, it may mean a single-layer feature map, and if L>1, it may mean a multi-layer feature map.

1) A feature map latent representation extraction means may be used to reduce the number of dimensions of an input image feature map. This feature map latent representation extraction means may use an image feature map as an input to perform at least one of the detailed processes of a feature map latent representation extraction means below and then output feature map latent representation y. The detailed process of a feature map latent representation extraction means below may be performed independently, but at least two detailed processes may be combined and performed into one process.

The detailed process of the feature map latent representation extraction means may include i) reducing the temporal or spatial resolution of an input image feature map, ii) expressing an input image feature map by compressing it into a smaller number of channels and iii) reducing the number of layers through fusion between layer feature maps when an input image feature map is a multi-layer feature map.

2) A feature map latent representation format conversion means may use feature map latent representation y as an input to perform at least one of the detailed processes of a feature map latent representation format conversion means below and then output converted feature map latent representation y_{c}. This conversion process may be used to convert the format of a feature map latent representation so that it may be used as the input of a feature map latent representation encoding means or to improve the encoding efficiency of a feature map latent representation encoding and decoding means. However, a feature map latent representation format conversion means may be omitted according to the type of a feature map latent representation encoding and decoding means.

The detailed process of the feature map latent representation format conversion means may include i) rearranging the dimension of a feature map latent representation and ii) performing quantization on the component values of a feature map latent representation.

3) A feature map latent representation encoding means may output an encoded bitstream by using converted feature map latent representation y_{c} as an input.

As an example, a reduced feature map encoding means may be performed through the encoder of a standard video codec such as High Efficiency Video Coding (HEVC) or Versatile Video Coding (VVC).

As an example, a reduced feature map encoding means may be performed through an artificial neural network-based entropy encoding method.

As an embodiment, a multi-layer feature map decoding method for reconstructing a multi-layer feature map from a bitstream output through an image feature map encoding method described above may include 1) a feature map reconstruction means, 2) a feature map latent representation format inverse conversion means and 3) a feature map latent representation decoding means.

A general process of performing image feature map decoding may be described through FIG. 11 and processes 4) to 6) below.

4) A feature map latent representation decoding means may reconstruct converted feature map latent representation \hat{ }y_{c} by using a bitstream as an input. For reference, the reconstructed data of the present disclosure, i.e., intermediate and final outputs from a decoder, may be indicated with a sign of \hat{ }( ) (hat).

As an example, a feature map latent representation decoding means may use the decoder of a standard video codec such as High Efficiency Video Coding (HEVC) or Versatile Video Coding (VVC).

As an example, a feature map latent representation decoding means may use an artificial neural network-based entropy decoding method.

5) A feature map latent representation format inverse conversion means is the reverse process of the feature map latent representation format conversion means of a feature map encoding method, and may use converted feature map latent representation \hat{ }y, as an input to perform at least one of the detailed processes of a feature map latent representation format inverse conversion means below and then reconstruct reconstructed feature map latent representation \hat{ }y. However, a feature map latent representation format inverse conversion means may be omitted according to the type of a feature map latent representation decoding means.

The detailed process of the feature map latent representation format inverse conversion means may include i) rearranging the dimension of a reconstructed feature map latent representation and ii) performing dequantization on the component values of a reconstructed feature map latent representation.

6) A feature map reconstruction means may be used to reconstruct an original feature map from information inherent in a feature map latent representation. This feature map reconstruction means may use reconstructed feature map latent representation \hat{ }y as an input to perform at least one of the detailed processes of a feature map reconstruction means below and then reconstruct feature map {\hat{ }Xₖ}_{(k=1, . . . , L)}. The detailed process of a feature map reconstruction means below may be performed independently, but at least two processes may be combined and performed into one process.

The detailed process of the feature map reconstruction means may include i) reconstructing each layer of an original feature map from a feature map latent representation, ii) reconstructing the temporal or spatial resolution of a feature map and iii) reconstructing the number of channels of a feature map.

In the present disclosure, a feature map latent representation extraction block is blocks configuring a feature map latent representation extraction means, which refers to the unit of a structure configured by a dimension reduction and expansion technique or a classical filtering technique for neural network block or image processing commonly used in an artificial neural network-based image processing technique and may have the following features.

The feature map latent representation extraction block of the present disclosure may include a neural network structure such as a convolution layer, a transposed convolution layer, a fully connected layer and a vision transformer.

As an example, a feature map latent representation extraction block may include a non-linear function such as Rectified Linear Unit (ReLU), Tangent Hyperbolic (Tanh), Sigmoid function, etc.

As an example, a feature map latent representation extraction block may include an element-wise arithmetic operation such as a residual (skip) connection.

As an example, a feature map latent representation extraction block may include a downsampling technique such as bilinear interpolation or bicubic interpolation.

As an example, a feature map latent representation extraction block may include an upsampling technique such as bilinear extrapolation or bicubic extrapolation.

As an example, a feature map latent representation extraction block may perform dimension reduction or dimension expansion on an input by adjusting the number of the strides of a used neural network structure (a convolution layer, a fully connected layer) or the nodes of a hidden layer, and particularly, it may increase or decrease the spatial resolution (width, height) of an input.

In the following description, a feature map latent representation extraction block (s⬆) may refer to a feature map latent representation extraction block that increases the width and height of an input by s times, and a feature map latent representation extraction block (s⬇) may refer to a feature map latent representation extraction block that decreases the width and height of an input by s times.

In the present disclosure, a feature map reconstruction block is blocks configuring a feature map reconstruction means, which refers to the unit of a structure configured by a dimension reduction and expansion technique or a classical filtering technique for neural network block or image processing commonly used in an artificial neural network-based image processing technique and may have the following features.

The feature map reconstruction block of the present disclosure may include a neural network structure such as a convolution layer, a transposed convolution layer, a fully connected layer and a vision transformer.

As an example, the feature map reconstruction block of the present disclosure may include a non-linear function such as Rectified Linear Unit (ReLU), Tangent Hyperbolic (Tanh), Sigmoid function, etc.

As an example, the feature map reconstruction block of the present disclosure may include an element-wise arithmetic operation such as a residual (skip) connection.

As an example, the feature map reconstruction block of the present disclosure may include a downsampling technique such as bilinear interpolation or bicubic interpolation.

As an example, the feature map reconstruction block of the present disclosure may include an upsampling technique such as bilinear extrapolation or bicubic extrapolation.

As an example, the feature map reconstruction block of the present disclosure may perform dimension reduction or dimension expansion on an input by adjusting the number of the strides of a used neural network structure (a convolution layer, a fully connected layer) or the nodes of a hidden layer, and particularly, it may increase or decrease the spatial resolution (width, height) of an input.

In the following description, a feature map reconstruction block (s⬆) may refer to a feature map reconstruction block that increases the width and height of an input by s times, and a feature map reconstruction block (s⬇) may refer to a feature map reconstruction block that decreases the width and height of an input by s times.

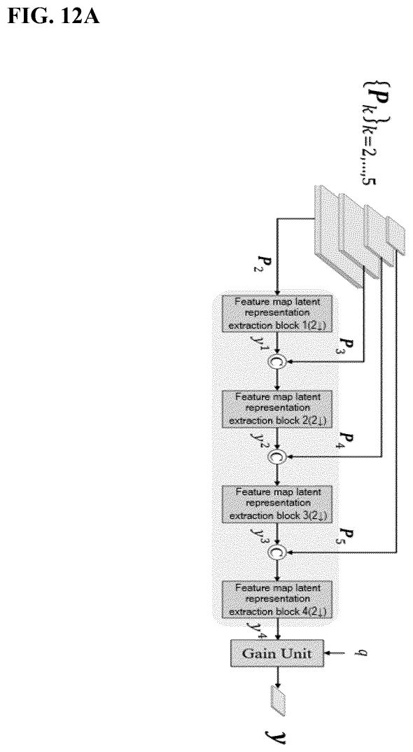

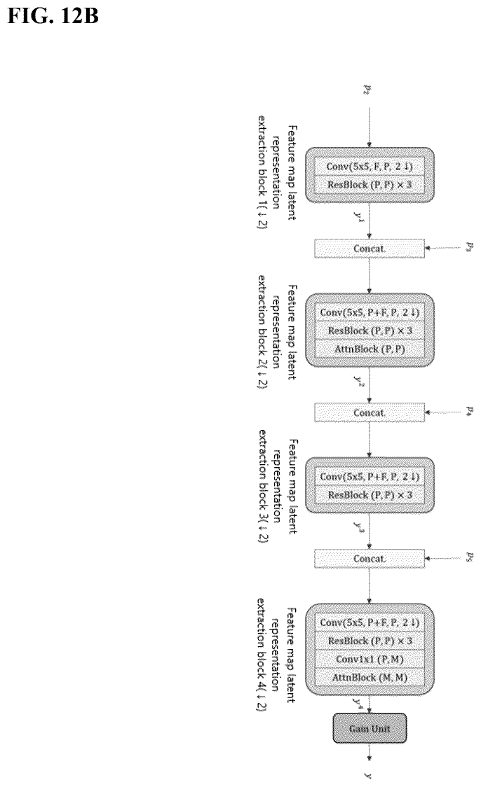

FIGS. 12A and 12B illustrate an example of the structure of a feature map latent representation extraction means.

For convenience of a description, this example assumes a case in which a P-layer feature map is encoded among the multi-layer feature maps.

FENet consists of a series of multi-layer feature map reduction blocks (multi-layer feature map reduction blocks 1, 2, 3 and 4), which may sequentially fuse and convert a multi-layer feature map to output reduced feature map y.

Feature map latent representation extraction block 1 may use feature map P₂ of the lowest layer as an input to reduce spatial resolution by ½ times in width and by ½ times in height compared to an input and to output feature map y¹ having P, the number of channels. (In this case, y¹ may be referred to as the i-th intermediate latent feature map.)

Feature map latent representation extraction block 2 may use the inter-channel concatenation of the first intermediate latent feature map y¹ and layer feature map P₃ having the same spatial resolution as an input to reduce spatial resolution by ½ times in width and by ½ times in height compared to an input and to output the second intermediate latent feature map y² having P, the number of channels.

Feature map latent representation extraction block 3 may use the inter-channel concatenation of the second intermediate latent feature map y² and layer feature map P₄ having the same spatial resolution as an input to reduce spatial resolution by ½ times in width and by ½ times in height compared to an input and to output the second intermediate latent feature map y³ having P, the number of channels.

Feature map latent representation extraction block 4 may use the inter-channel concatenation of the third intermediate latent feature map y³ and layer feature map P₅ having the same spatial resolution as an input to reduce spatial resolution by ½ times in width and by ½ times in height compared to an input and to output the second intermediate latent feature map y⁴ having P, the number of channels.

The fourth intermediate latent feature map y⁴ may be considered as feature map latent representation y, which may additionally go through scaling for each channel by a gain unit.

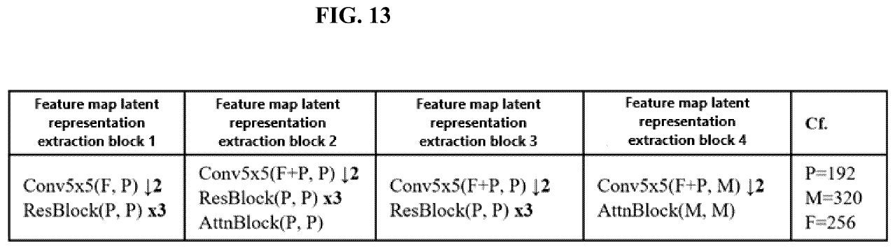

The specific configuration of each multi-layer feature map reduction block is described later in FIGS. 13 to 15.

FIG. 13 illustrates an example of the configuration of feature map latent representation extraction blocks used in FIG. 12A.

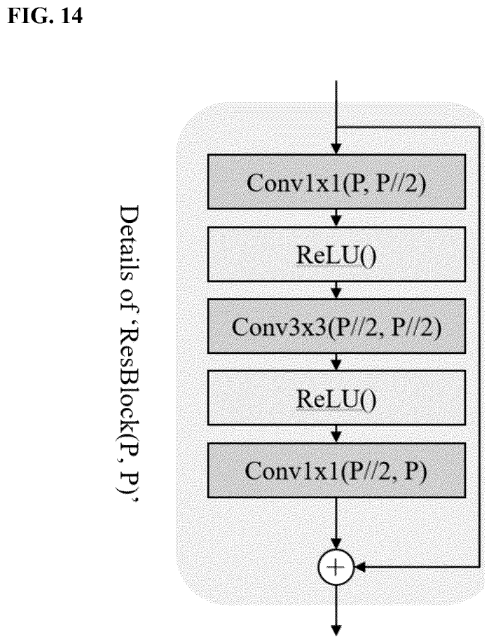

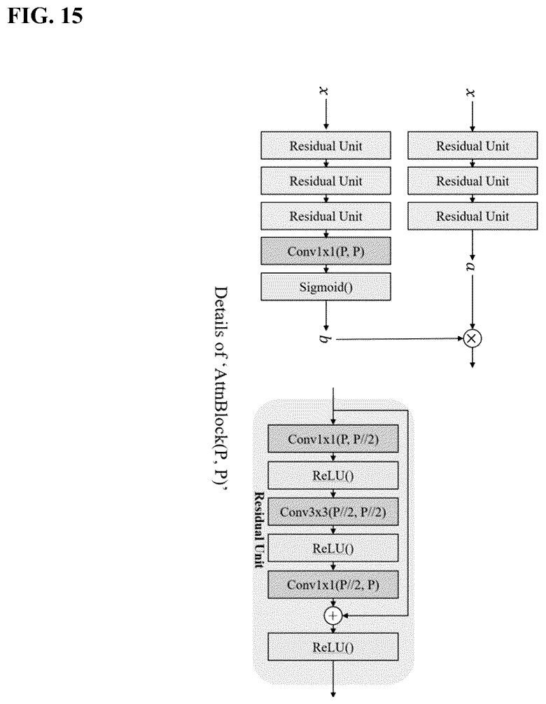

FIGS. 14 and 15 illustrate the detailed structure of a neural network block used in FIGS. 12A and 12B.

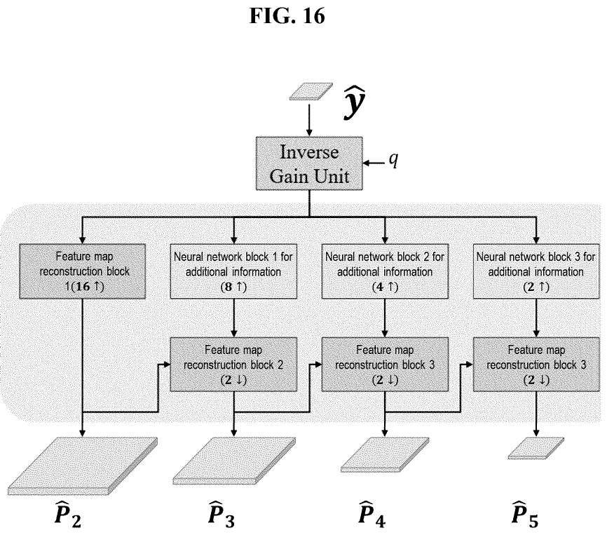

FIG. 16 illustrates an example of the structure of a feature map reconstruction means.

For convenience of a description, this example assumes a case in which a P-layer feature map is decoded among the multi-layer feature maps by using reduced feature map \hat{ }y as an input after performing feature reduction on the P-layer feature map. However, feature map latent representation \hat{ }y reconstructed in this case may be compressed and reconstructed by a feature map latent representation encoder and decoder.

As an example, a feature map reconstruction means consists of a series of feature map reconstruction blocks 1, 2, 3 and 4 and neural network blocks 1, 2 and 3 for additional information, and may output image feature map {\hat{ }Pₖ}_{(k=2, . . . , 5)} by sequentially reconstructing each layer feature map of a multi-layer feature map.

Scaling for each channel may be additionally performed by an inverse gain unit on reconstructed feature map latent representation \hat{ }y.

Feature map reconstruction block 1 may reconstruct feature map \hat{ }P₂ of the lowest layer by using reconstructed feature map latent representation \hat{ }y as an input.

Feature map reconstruction block 2 may reconstruct feature map \hat{ }P₃ of the next layer by using layer feature map \hat{ }P₂, which is the output of feature map reconstruction block 1, as an input and using the output of neural network block 1 for additional information as an additional input at the same time.

Feature map reconstruction block 3 may reconstruct feature map \hat{ }P₄ of the next layer by using layer feature map \hat{ }P₃, which is the output of feature map reconstruction block 2, as an input and using the output of neural network block 2 for additional information as an additional input at the same time.

Feature map reconstruction block 4 may reconstruct feature map \hat{ }P₅ of the next layer by using layer feature map \hat{ }P₄, which is the output of feature map reconstruction block 3, as an input and using the output of neural network block 3 for additional information as an additional input at the same time.

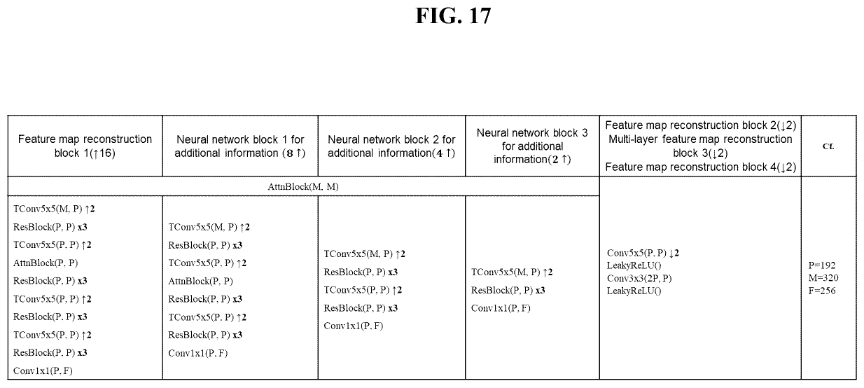

FIG. 17 illustrates an example of the configuration of neural network blocks for additional information and feature map reconstruction blocks used in FIG. 16.

In FIG. 17, TConv5x5 (P, P) ⬆2 may represent a transposed convolutional neural network with a typical 5×5-sized kernel and a stride of 2.

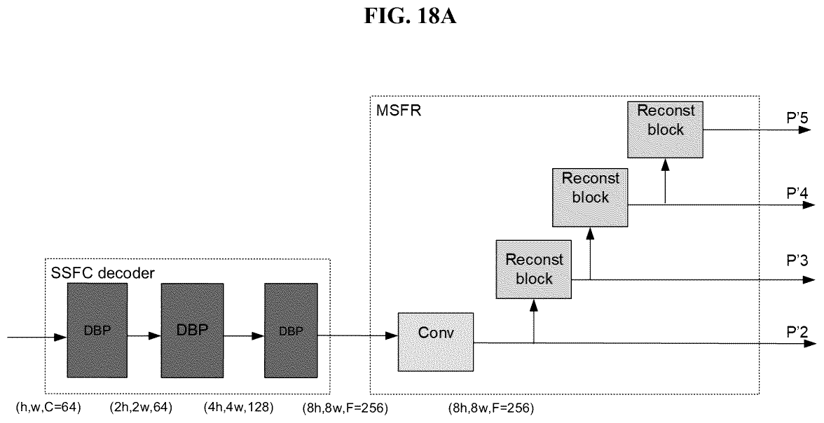

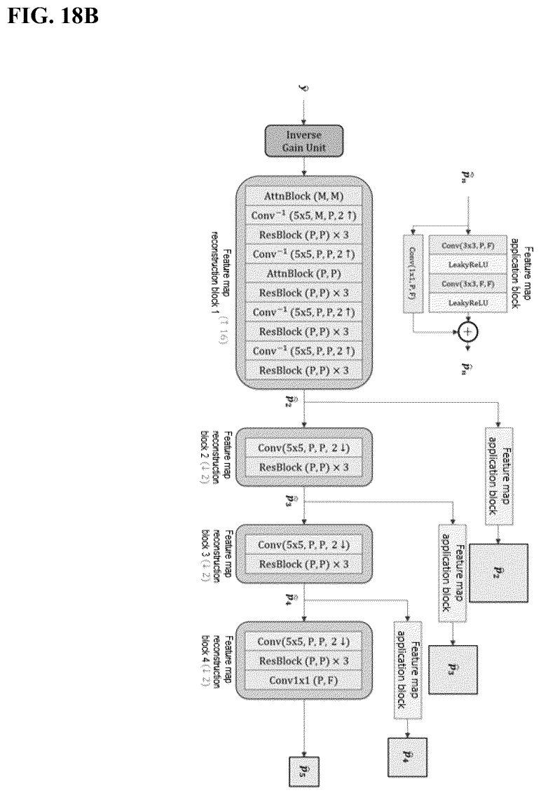

FIG. 18A illustrates another example of a feature map reconstruction means.

FIG. 18B illustrates an example of a feature map reconstruction means.

For convenience of a description, this example assumes a case in which a P-layer feature map is decoded among the multi-layer feature maps by using reduced feature map \hat{ }y as an input after performing feature reduction on the P-layer feature map. However, feature map latent representation \hat{ }y reconstructed in this case may be compressed and reconstructed by a feature map latent representation encoder and decoder.

As an example, a feature map reconstruction means consists of a series of feature map reconstruction blocks 1, 2, 3 and 4 and feature map application blocks, and may output image feature map {\hat{ }Pₖ}_{(k=2, . . . , 5)} by sequentially reconstructing each layer feature map of a multi-layer feature map.

Scaling for each channel may be additionally performed by an inverse gain unit on reconstructed feature map latent representation \hat{ }y.

Feature map reconstruction block 1 may generate intermediate latent feature map ˜\hat{ }p₂ by using reconstructed feature map latent representation \hat{ }y as an input.

Feature map reconstruction block 2 may generate intermediate latent feature map ˜\hat{ }p₃ by using intermediate latent feature map ˜\hat{ }p₂, which is the output of feature map reconstruction block 1, as an input. (In this case, ˜\hat{ }pi may be referred to as the i-th intermediate latent feature map.)

Feature map reconstruction block 3 may generate intermediate latent feature map ˜\hat{ }p₄ by using intermediate latent feature map ˜\hat{ }p₃, which is the output of feature map reconstruction block 2, as an input.

Each of intermediate latent feature maps ˜\hat{ }p₂, ˜\hat{ }p₃ and ˜\hat{ }p₄ may be reconstructed into layer feature maps \hat{ }p₂, \hat{ }p₃ and \hat{ }p₄ through a feature map application block.

Feature map reconstruction block 4 may reconstruct layer feature map \hat{ }p₅ by using intermediate latent feature map ˜\hat{ }p₄, which is the output of feature map reconstruction block 3, as an input.

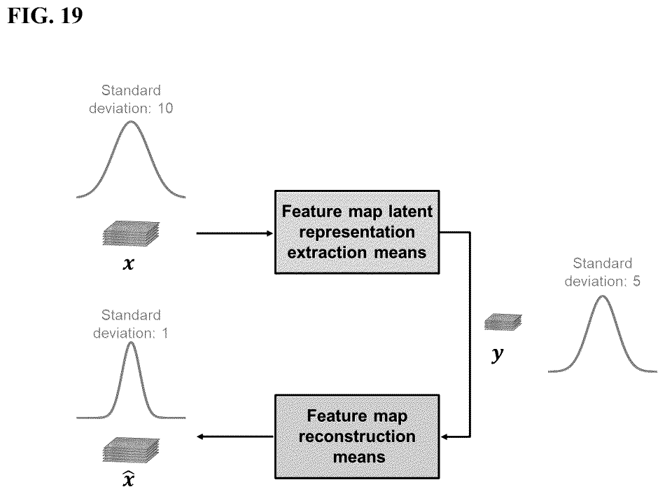

FIG. 19 illustrates an example of the influence of a feature map latent representation extraction means and a feature map reconstruction means on the feature map value distribution.

Regarding the influence of a neural network-based feature map latent representation extraction means and a feature map reconstruction means on the distribution of feature map values, conventional artificial neural networks generate an output signal with distribution different from the distribution of an input signal and an output signal may largely have a narrower distribution than an input signal.

Accordingly, a neural network-based feature map latent representation extraction means or a feature map reconstruction means may output a feature map with a narrower distribution than an input feature map.

In other words, a feature map latent representation which is the output of a feature map latent representation extraction means may have a narrower distribution than an input feature map, and a reconstructed feature map which is the output of a feature map reconstruction means may have a narrower distribution than a reconstructed feature map latent representation.

In addition, a finally reconstructed feature map may have a narrower distribution than an input feature map.

FIG. 19 may represent only a feature map reconstruction means and a feature map latent representation extraction means consisting of artificial neural networks in the image feature map encoding and decoding means of FIG. 11. Input feature map x extracts feature map latent representation y through a feature map latent representation extraction means consisting of artificial neural networks, and the distribution of a feature map latent representation may be narrower than the distribution of an input feature map. In addition, since a feature map reconstruction means also consists of artificial neural networks, the distribution of reconstructed feature map \hat{ }x may be narrower than the distribution of a feature map latent representation.

The present disclosure expands the distribution of feature map latent representations and uses it as the input of a feature map reconstruction means to match the distributions of an input feature map and a reconstructed feature map by considering that a neural network-based feature map latent representation extraction means and a feature map reconstruction means reduce the distribution of output feature maps compared to input feature maps.

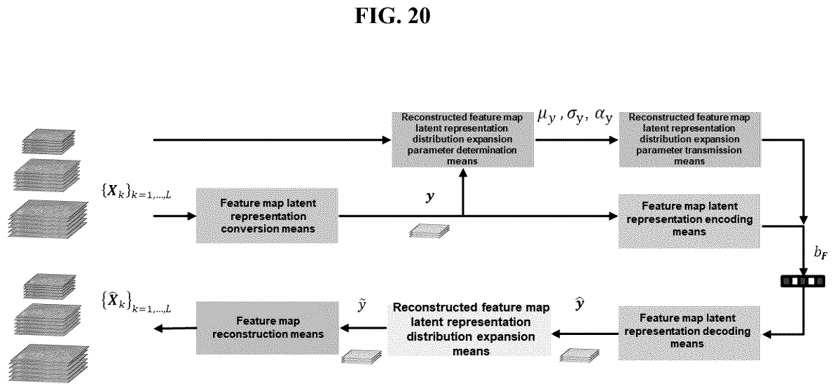

FIG. 20 illustrates an embodiment of an encoding and decoding process for an image feature map including a means for reconstructed feature map latent representation distribution expansion.

As in FIG. 20, the present disclosure includes a reconstructed feature map latent representation distribution expansion means in encoding and decoding an image feature map, and may expand the distribution of reconstructed feature map latent representation \hat{ }y through a reconstructed feature map latent representation distribution expansion means and convert it into distribution-expanded feature map latent representation ˜y having a wider distribution than the distribution of feature map latent representation y.

The present disclosure may include a reconstructed feature map latent representation distribution expansion means in encoding and decoding an image feature map and include a reconstructed feature map latent representation distribution expansion parameter determination means and a reconstructed feature map latent representation distribution expansion parameter transmission means in performing encoding, and may expand the distribution of reconstructed feature map latent representation \hat{ }y through a reconstructed feature map latent representation distribution expansion means and convert it into distribution-expanded feature map latent representation ˜y having a wider distribution than the distribution of feature map latent representation y.

In the process, a distribution expansion parameter determined from a reconstructed feature map latent representation distribution expansion parameter determination means may be transmitted through a reconstructed feature map latent representation distribution expansion parameter transmission means, and the transmitted parameter may be used as a parameter transmitted from a reconstructed feature map latent representation distribution expansion means.

A distribution expansion means for a reconstructed feature map latent representation May 1) compensate only for the distribution of a reconstructed feature map latent representation, not the distribution of a reconstructed feature map. 2) In compensating for the distribution of a reconstructed feature map latent representation, distribution may be expanded to have a wider distribution than the distribution of a feature map latent representation. In this case, Equations 5 and 6 below may be used. 3) Feature map latent representation distribution expansion degree parameter a_{y} may use a predefined value to receive and use a value that is determined in an encoding process or known by a decoder.

When determining a feature map latent representation distribution expansion parameter in an encoding process, a value may be used that is defined by analyzing the statistical characteristics of data or is derived by using algorithm and artificial neural network structures.

$$\tilde{y} = \frac{\hat{y} - {μ}_{\hat{y}}}{{σ}_{\hat{y}}} \times ( {σ}_{y} \times {α}_{y} ) + {μ}_{y} , {α}_{y} \geq 1 \qquad Equation 5$$

$${\tilde{y}}^{c} = \frac{{\hat{y}}^{c} - {μ}_{\hat{y}}^{c}}{{σ}_{\hat{y}}^{c}} \times ( {σ}_{y}^{c} \times {α}_{y}^{c} ) + {μ}_{y}^{c} , {α}_{y}^{c} \geq 1 for at least one c \qquad Equation 6$$

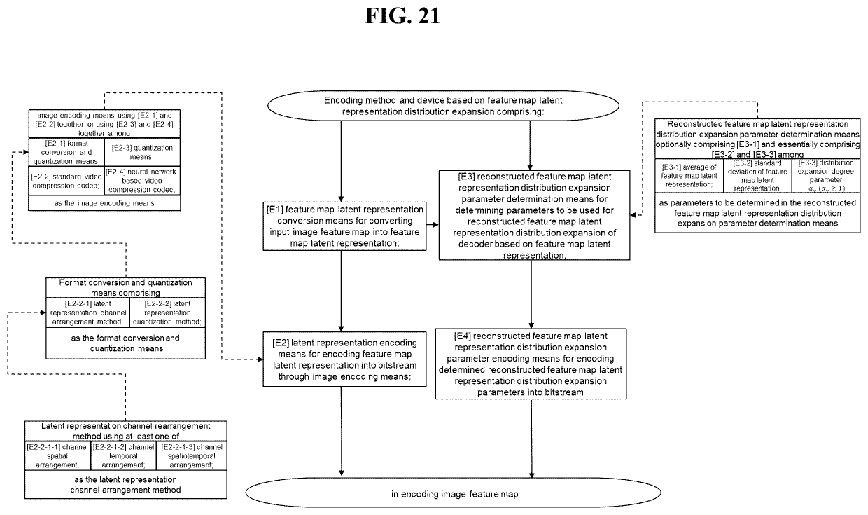

FIG. 21 illustrates an example of a feature map encoding process.

An encoding method and device based on feature map latent representation distribution expansion may include [E1] a feature map latent representation conversion means for converting an input image feature map into a feature map latent representation; [E2] a latent representation encoding means for encoding a feature map latent representation into a bitstream through an image encoding means; [E3] a reconstructed feature map latent representation distribution expansion parameter determination means for determining parameters to be used for the reconstructed feature map latent representation distribution expansion of a decoder based on a feature map latent representation; and [E4] a reconstructed feature map latent representation distribution expansion parameter encoding means for encoding determined reconstructed feature map latent representation distribution expansion parameters into a bitstream.

The image encoding means may use [E2-1] and [E2-2] together or [E2-3] and [E2-4] together among [E2-1] a format conversion and quantization means, [E2-2] a standard video compression codec, [E2-3] a quantization means and [E2-4] a neural network-based video compression codec.

The format conversion and quantization means may include [E2-2-1] a latent representation channel arrangement method and [E2-2-2] a latent representation quantization method.

The latent representation channel arrangement method may use at least one of [E2-2-1-1] channel spatial arrangement; [E2-2-1-2], channel temporal arrangement or [E2-2-1-3] channel spatiotemporal arrangement.

The reconstructed feature map latent representation distribution expansion parameter determination means may optionally include [E3-1] and [E3-2] and essentially include [E3-3] among [E3-1] the average of feature map latent representations, [E3-2] the standard deviation of feature map latent representations and [E3-3] distribution expansion degree parameter a_{y} (a_{y}≥1).

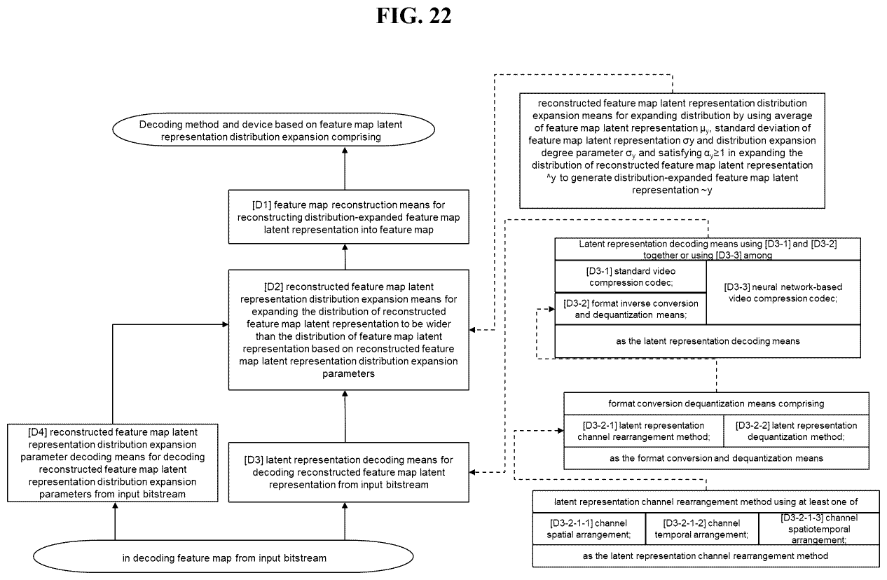

FIG. 22 illustrates an example of a feature map decoding process.

A decoding method and device based on feature map latent representation distribution expansion may include [D3] a latent representation decoding means for decoding a feature map latent representation reconstructed from an input bitstream; [D4] a reconstructed feature map latent representation distribution expansion parameter decoding means for decoding feature map latent representation distribution expansion parameters reconstructed from an input bitstream; [D2] a reconstructed feature map latent representation distribution expansion means for expanding the distribution of reconstructed feature map latent representations to be wider than the distribution of feature map latent representations based on reconstructed feature map latent representation distribution expansion parameters and [D1] a feature map reconstruction means for reconstructing a distribution-extended feature map latent representation into a feature map.

The reconstructed feature map latent representation distribution expansion means may expand the distribution by using μ_{y}, the average of feature map latent representations, σ_{y}, the standard deviation of feature map latent representations, and a_{y}, a distribution expansion degree parameter, and satisfy a_{y}≥1 in generating distribution-extended feature map latent representation ˜y by expanding the distribution of reconstructed feature map latent representations \hat{ }y.

The latent representation decoding means may use [D3-1] and [D3-2] together or use [D3-3] among [D3-1] a standard video compression codec, [D3-2] a format inverse conversion and dequantization means and [D3-3] a neural network-based video compression codec.

The format conversion and dequantization means may include [D3-2-1] a latent representation channel rearrangement method and [D3-2-2] a latent representation dequantization method.

The latent representation channel rearrangement method may use at least one of [D3-2-1-1] channel spatial arrangement; [D3-2-1-2], channel temporal arrangement or [D3-2-1-3] channel spatiotemporal arrangement.

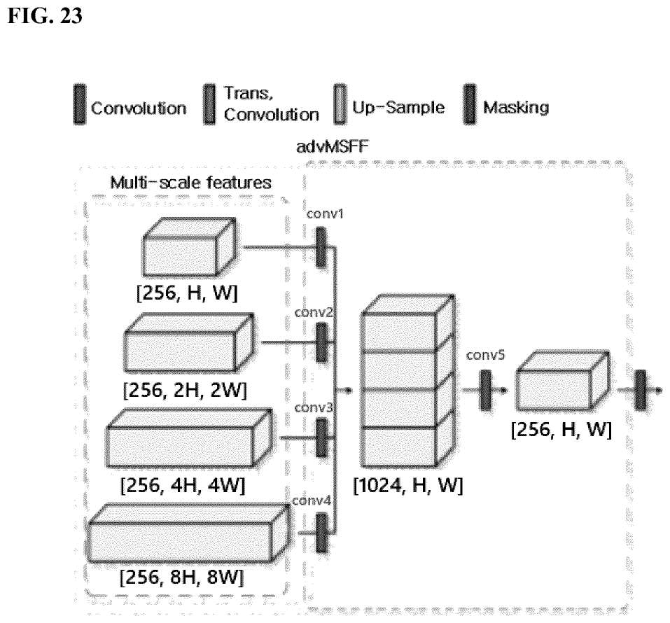

FIG. 23 illustrates an example of a feature map latent representation extraction means.

A feature map latent representation extraction means may receive a general image, a multi-layer feature map or a single-layer feature map as an input and extract a feature map latent representation.

A feature map latent representation extraction means consists of artificial neural networks, and an example as shown in FIGS. 12A, 12B, 18A and 23 may be used.

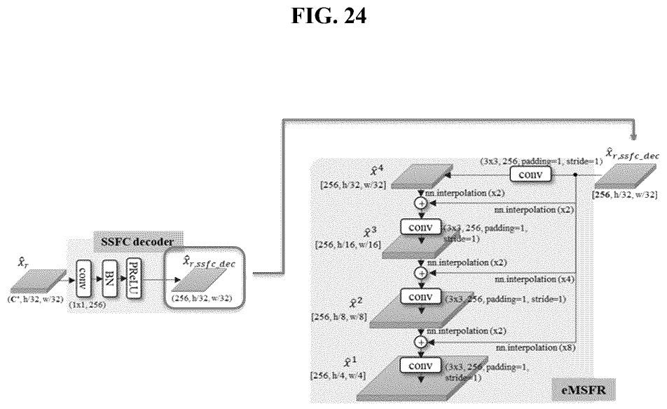

FIG. 24 illustrates an example of a feature map reconstruction means.

A feature map reconstruction means may receive a reconstructed feature map latent representation as an input and reconstruct it into an image, a multi-layer feature map or a single-layer feature map. In the present disclosure, a feature map obtained by reconstructing a reconstructed feature map latent representation in a feature map reconstruction means may be expressed as a reconstructed feature map.

A feature map reconstruction means consists of artificial neural networks, and an example as shown in FIGS. 16, 18B and 24 may be used.

A feature map latent representation may be encoded into a bitstream through a latent representation encoding means, and a bitstream may be reconstructed into a feature map latent representation through a latent representation decoding means.

As a latent representation encoding and decoding means, a standard video compression codec [E2-2][D3-1] or a neural network-based video compression codec [E2-4][D3-3] may be used.

As an example for a standard video compression codec, an existing video compression codec such as HEVC or VVC may be used.

When a standard video compression codec is used as a latent representation encoding means, a format conversion and quantization means [E2-1] for converting and quantizing the format of a feature map latent representation must be used together, and a format inverse conversion and dequantization means [D3-2] may need to be used together in a decoder.

When a neural network-based video compression codec [E2-4][D3-3] is used, a quantization means [E2-3] must be used together in an encoder, and only [D3-3] may be used in a decoder.

A reconstructed feature map latent representation distribution expansion means may expand the distribution of reconstructed feature map latent representations \hat{ }y to generate distribution-expanded feature map latent representation ˜y.

In this case, in expanding the distribution of feature map latent representation \hat{ }y, the distribution is expanded by using μ_{y}, the average of feature map latent representations, σ_{y}, the standard deviation of feature map latent representations, and a_{y}, a distribution expansion degree parameter, a_{y}≥1 is satisfied. When expanding the distribution, Equations 7 to 10 below may be used.

$$\tilde{y} = \frac{\hat{y} - {μ}_{\hat{y}}}{{σ}_{\hat{y}}} \times ( {σ}_{y} \times {α}_{y} ) + {μ}_{y} \qquad Equation 7$$

$$\tilde{y} = \frac{\hat{y} - {μ}_{\hat{y}}}{{σ}_{\hat{y}}} \times ( {σ}_{y} \times {α}_{y} ) + {μ}_{\hat{y}} \qquad Equation 8$$

$$\tilde{y} = \frac{\hat{y}}{{σ}_{\hat{y}}} \times ( {σ}_{y} \times {α}_{y} ) \qquad Equation 9$$

$$\tilde{y} = \hat{y} \times {α}_{y} \qquad Equation 10$$

Distribution expansion degree parameter a_{y} may have one value for a reconstructed feature map latent representation, and in this case, the average value of reconstructed feature maps may be calculated by using Equation 11 and a standard deviation value thereof may be calculated by using Equation 12.

Distribution expansion degree parameter a_{y} may have a different value for each channel of a reconstructed feature map latent representation. In other words, a_{y} may be a vector having the same length as C, the channel length of a reconstructed feature map latent representation. In this case, when there is distribution expansion degree parameter a_{y}^{c} for channel c, a distribution expansion degree parameter for at least one channel satisfies a_{y}^{c}≥1. In this case, the average value per channel of reconstructed feature maps may be calculated by using Equation 13, and a standard deviation value per channel may be calculated by using Equation 14.

$${μ}_{\hat{y}} = \frac{1}{WHC} {\sum }_{w ∈ W} {\sum }_{h ∈ H} {\sum }_{c ∈ C} \hat{y} ( w , h , c ) \qquad Equation 11$$

$${σ}_{\hat{y}} = \sqrt{\frac{1}{WHC} {\sum }_{w ∈ W} {\sum }_{h ∈ H} {\sum }_{c ∈ C} {( \hat{y} ( w , h , c ) - {μ}_{\hat{y}} )}^{2}} \qquad Equation 12$$

$${σ}_{\hat{y}}^{c} = \frac{1}{WH} {\sum }_{w ∈ W} {\sum }_{h ∈ H} \hat{y} ( w , h ) \qquad Equation 13$$

$${σ}_{\hat{y}}^{c} = \sqrt{\frac{1}{WH} {\sum }_{w ∈ W} {\sum }_{h ∈ H} {( \hat{y} ( w , h ) - {μ}_{\hat{y}}^{c} )}^{2}} \qquad Equation 14$$

A reconstructed feature map latent representation distribution expansion parameter determination means determines μ_{y}, the average of feature map latent representations, σ_{y}, the standard deviation of feature map latent representations, and a_{y}, a distribution expansion degree parameter. In this case, the average and standard deviation of feature map latent representations and a distribution expansion degree parameter may use one scalar value for one feature map latent representation.

In addition, each channel of one feature map latent representation may have one value.

In other words, μ_{y}, σ_{y} and a_{y} may be a vector having the same length as C, the channel length of a reconstructed feature map latent representation. In this case, it may be applied as in Equation 6. In this case, when there is distribution expansion degree parameter a_{y}^{c} for channel c, a distribution expansion degree parameter for at least one channel satisfies a_{y}^{c}≥1.

Distribution expansion degree parameter a_{y} may be predefined in a reconstructed feature map latent representation distribution expansion means, or may use a value that is determined in a reconstructed feature map latent representation distribution expansion parameter determination means.

When distribution expansion degree parameter a_{y} is predefined in a reconstructed feature map latent representation distribution expansion means, distribution expansion degree parameter a_{y} that makes optimal performance from a variety of data may be predefined to perform a decoding task without a separate distribution expansion degree parameter search process or transmission.

When a value determined in a reconstructed feature map latent representation distribution expansion parameter determination means is used as distribution expansion degree parameter a_{y}, a task of searching for an optimal feature map latent representation distribution expansion parameter in a distribution expansion parameter determination means for input data may be performed and transmitted to a decoder through a reconstructed feature map latent representation distribution expansion parameter transmission means.

A feature map latent representation distribution expansion parameter may be determined and transmitted for each frame, transmitted for each frame I or transmitted for each number of specific frames.

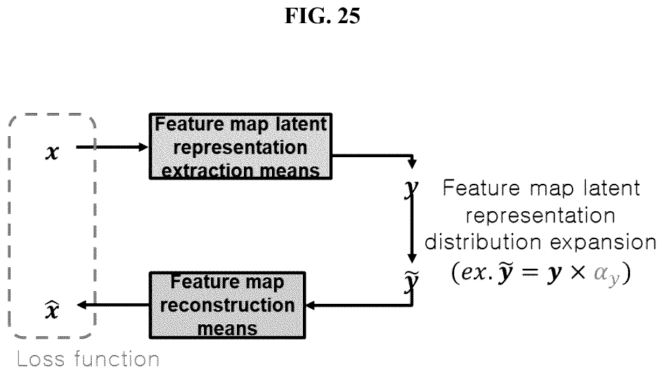

FIG. 25 illustrates an example of a process for learning a feature map latent representation extraction means and a feature map reconstruction means.

As a method for searching a feature map latent representation distribution expansion parameter, a parameter may be determined by analyzing the distribution of feature map latent representations, or may be derived by using an algorithm or an artificial neural network.

As the first example of a derivation method using an artificial neural network, learning for finding an optimal feature map latent representation distribution expansion degree parameter may be performed at once simultaneously in the process of learning a feature map latent representation extraction means and a feature map reconstruction means.

For example, in the process of learning a feature map latent representation extraction means and a feature map reconstruction means in FIG. 25, ˜y may be generated by applying feature map latent representation distribution expansion to y extracted through a feature map latent representation extraction means, and ˜y may be input to a feature map reconstruction means to apply a loss function to output \hat{ }x. In this case, Equations 7 to 14 may be used as feature map latent representation distribution expansion for generating ˜y, and a machine task loss function using \hat{ }x, a rate-machine task loss function or a distortion loss function or a rate-distortion loss function using \hat{ }x and x may be used as a loss function. In learning a feature map latent representation extraction means and a feature map reconstruction means, feature map latent representation distribution expansion degree parameter a_{y} used for feature map latent representation distribution expansion may also be learned simultaneously.

As the second example of a derivation method using an artificial neural network, additional learning for finding an optimal feature map latent representation distribution expansion degree parameter may be performed by using a feature map latent representation extraction means and a feature map reconstruction means that are already learned.

As the neural network parameters of a learned feature map latent representation extraction means and feature map reconstruction means are fixed, additional learning may be performed to obtain feature map latent representation distribution expansion degree parameter a_{y}. In this case, a machine task loss function using \hat{ }x, a rate-machine task loss function or a distortion loss function or a rate-distortion loss function using \hat{ }x and x may be used as a learning loss function.

Alternatively, by changing a feature map latent representation distribution expansion degree parameter by using a learned feature map latent representation extraction means and feature map reconstruction means, machine task performance when applying feature map latent representation distribution expansion may be confirmed and a feature map latent representation distribution expansion parameter that makes the most optimal performance may be determined.

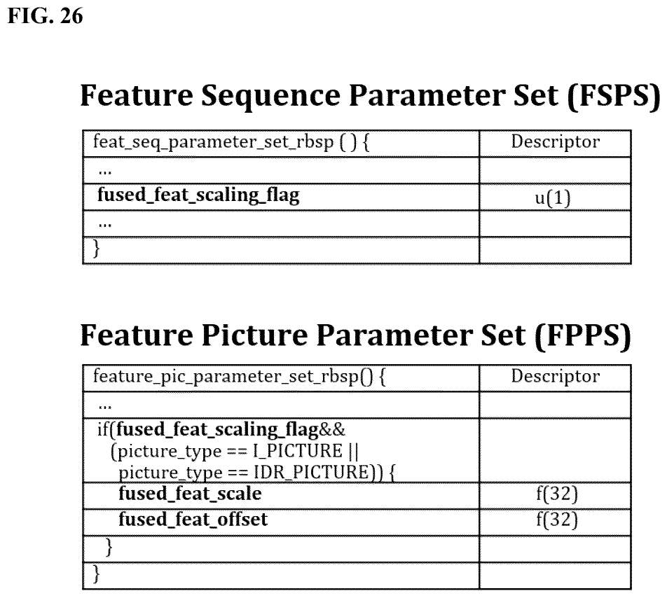

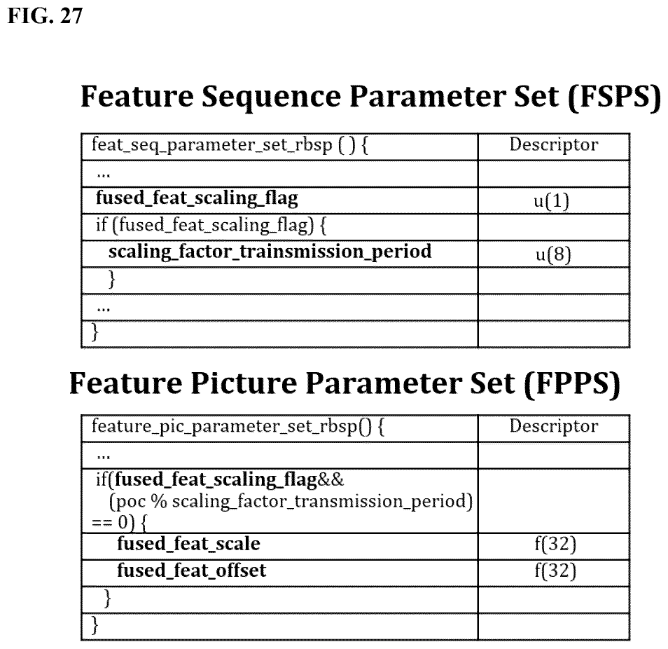

FIGS. 26 and 27 illustrate an example of syntax structures for a parameter for a reconstructed feature map latent representation distribution expansion means.

Referring to FIGS. 26 and 27, it may be understood that when fused_feat_scaling_flag is 1, relevant parameters are signaled for each frame I or for each number of specific frames. However, the present disclosure is not limited thereto, and other methods may also be used.

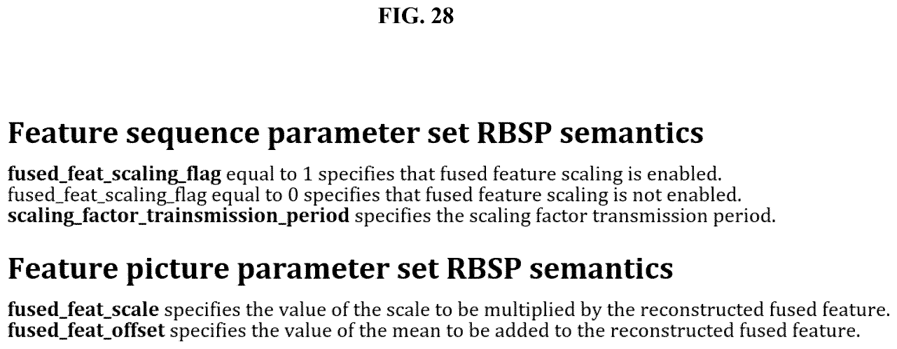

FIG. 28 illustrates an example of semantics for a parameter for a reconstructed feature map latent representation distribution expansion means.

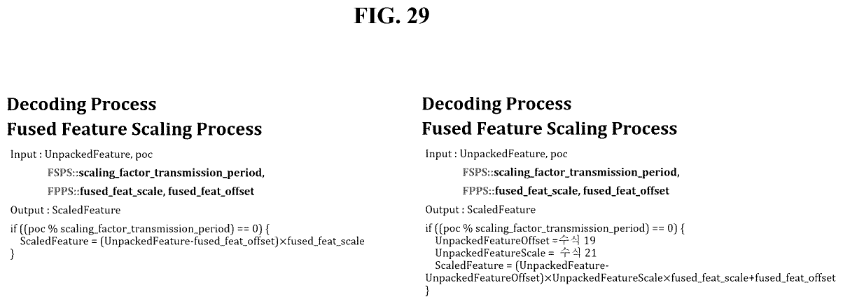

FIG. 29 illustrates an embodiment of a fused feature scaling process.

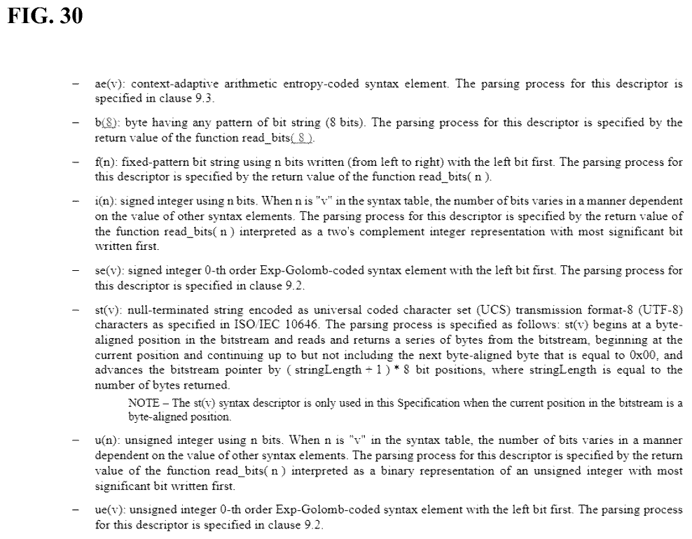

FIG. 30 illustrates methods for encoding and decoding a reconstructed feature map latent representation distribution expansion parameter.

Encoding and decoding a reconstructed feature map latent representation distribution expansion parameter may be performed by any one of the methods listed in FIG. 30.

When an extracted feature map latent representation does not match the input format of an image encoding means, adjustment is required, which may be performed in a format conversion and quantization means.

Inverse conversion may also be performed in a format inverse transform and dequantization means in a decoder to be the same format as feature map latent representation extracted from an encoder.

A format conversion and quantization process [E2-1] and a format inverse conversion and dequantization process [D3-2] may include any one of 1) a feature map latent representation channel arrangement and rearrangement method [E2-2-1][D3-2-1] and 2) a feature map latent representation quantization and dequantization method [E2-2-2][D3-2-2].

n, the number of bits used for feature map latent representation quantization, and min and max, the range of latent representations, may need to be transmitted to a format inverse conversion and dequantization means [D3-2].

In addition, only when a feature map latent representation rearrangement means must know parameters such as whether feature map latent representation channels are arranged spatially, temporally or spatiotemporally or the number of horizontal channels or the number of vertical channels configuring one frame if spatial or spatiotemporal arrangement is used, rearrangement may be performed according to an original channel configuration.

Accordingly, this format conversion and quantization information may be predetermined or encoded through a feature map encoding means, decoded by a feature map decoding means, and then transmitted to a format inverse conversion and dequantization means.

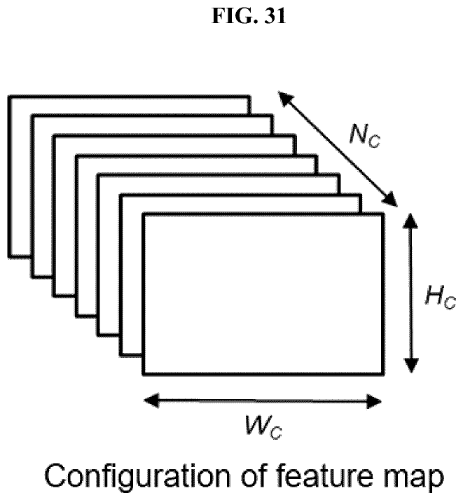

FIG. 31 illustrates an example of a feature map configuration.

A feature map is largely composed of multiple channels as shown in FIG. 31, and a feature map latent representation may also be composed of feature maps as shown in FIG. 31. Here, N_{C} may represent the number of channels, W_{C} may represent the width of a channel and H_{C} may represent the height of a channel.

In order to encode multiple channels, these channels may need to be converted in the form of a frame (or a picture), which is a unit input for encoding. In a feature map latent representation arrangement method, one of a spatial arrangement method, a temporal arrangement method and a spatio-temporal arrangement method may be used when converting channels into a frame. A feature map frame converted in this way may be compressed by the encoder of an video compression codec and reconstructed by the decoder of an video compression codec. A reconstructed feature map latent representation frame may be rearranged by a feature map latent representation rearrangement method in its original channel configuration form.

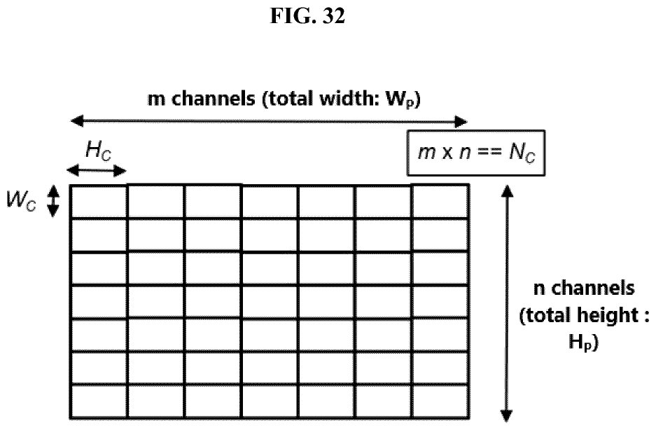

FIG. 32 illustrates an example of a spatially arranged feature map.

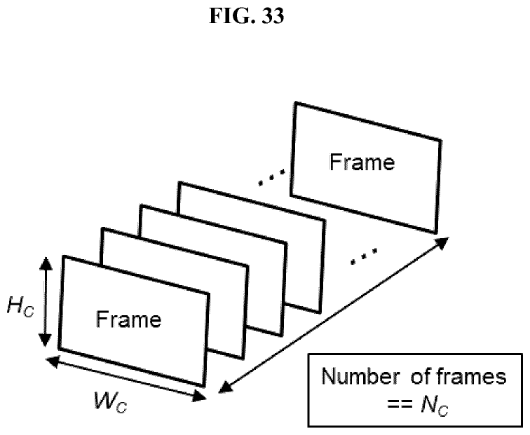

FIG. 33 illustrates an example of a temporally arranged feature map.

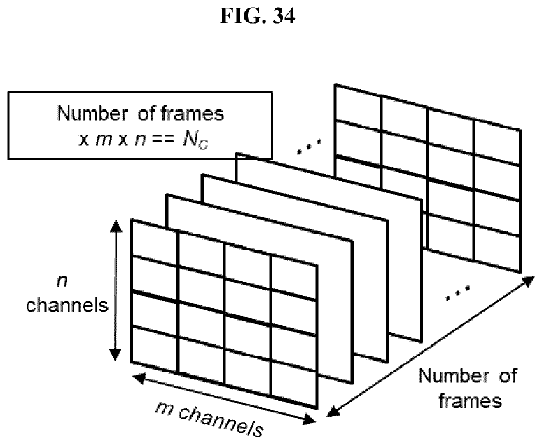

FIG. 34 illustrates an example of a spatiotemporally arranged feature map.

FIGS. 32, 33 and 34 may represent a spatial arrangement method [E2-2-1-1][D3-2-1-1], a temporal arrangement method [E2-2-1-2][D3-2-1-2] and a spatiotemporal arrangement method [E2-2-1-3][D3-2-1-3], respectively.

As shown in FIG. 32, spatial arrangement refers to arranging m horizontally and n vertically among the channels of a feature map latent representation in a form like a tile to configure one feature map latent representation frame, and m and n are configured to ensure that their product is the same as Nc, the total number of channels to be arranged. The frame of a spatially arranged feature map latent representation may be encoded by using an intra-frame prediction method in an encoding means.

The temporal arrangement refers to temporally arranging each channel of a feature map latent representation to be one frame as shown in FIG. 33, and the total number of frames for one feature map latent representation may be set to be the same as Nc, the total number of channels configuring that feature map latent representation. The frames of a temporally arranged feature map latent representation may be encoded by using an inter-frame prediction method in the encoder of an video compression codec. In the present disclosure, a term of ‘inter prediction’ which is widely used in the image encoding standard is used to help understanding, but in order to distinguish it from the existing inter prediction, it may be more appropriate to call it inter-channel prediction.

The spatiotemporal arrangement refers to temporally arranging frames which are spatially arranged as shown in FIG. 34, which may be set to ensure that a value obtained by multiplying m x n, the number of channels configuring one frame, by the total number of frames is the same as N_{C}, the total number of channels to be arranged.

Equation 15 may represent an exemplary equation for calculating the number of horizontal channels (m) and the number of vertical channels (n) for spatial arrangement [E2-1-1].

$$n = ( {log}_{2} ( {N}_{C} ) \%2 = 0 ) ? ( {2}^{⌊ \frac{{log}_{2} {N}_{C}}{2} ⌋} ) : ( {2}^{⌊ \frac{{log}_{2} {N}_{C}}{2} ⌋ + 1} ) \qquad Equation 15$$

$$m = \frac{{N}_{C}}{n}$$

A decoder must use n and m values that are the same as those used in an encoder for feature map latent representation rearrangement. For this purpose, n and m values may be transmitted to a decoder through a bitstream or may be calculated and used in a decoder through the same equation as that used in an encoder.

The quantization of a feature map latent representation may be quantized into n-bit (n=bitdepth) integers by using a uniform quantization or non-uniform quantization method.

Equations 16 and 17 represent the n-bit uniform quantization process of feature value xₚ and the uniform dequantization process of reconstructed feature value \hat{ }x_{q}, respectively.

In a quantization process, rounding, rounding up, rounding down, etc. may be applied to reduce an error in an integerization process, and the process of clipping values exceeding the range of n-bit integers may be included.

For quantization and dequantization, the value of n, which is the number of bits of a quantized result, and the value of min and max, which are the range of feature values, must be set. A value of n may be set as a value that may be input to a typical image encoder such as 8 or 10, or may be set as a smaller value such as 4 or 6 to improve compression performance. The min and max values may be obtained from the maximum and minimum values of feature values to be encoded, or may use a predetermined value. The min and max values may be used for each machine vision task, dataset, image sequence or frame.

As a value of n and min and max values described above are a parameter related to feature value quantization, a value used in an encoding process must be used in the same way in a decoding process as well, so they may be predetermined in a feature map encoder or may be included in a bitstream and transmitted to a feature map decoder.

In addition, Equation 18 may be used instead of Equation 17, in which case only the value of n may be predetermined in a feature map encoder or may be included in a bitstream and transmitted to a feature map decoder.

The quantization of a latent representation may be performed before or after the latent representation arrangement.

The dequantization of a latent representation may also be performed before or after latent representation rearrangement, but if latent representation quantization is performed before latent representation arrangement, dequantization may be performed after rearrangement, and if latent representation quantization is performed after latent representation arrangement, dequantization may be performed before rearrangement, thereby reducing calculation errors.

$$max\_num \_bits = {2}^{bitdepth} - 1 \qquad Equation 16$$

$${x}_{q} = ⌈ max ( min ( \frac{{x}_{p} - min}{max - min} , 0 ) , 1 ) \times max\_num \_bits ⌉$$

$$max\_num \_bits = {2}^{bitdepth} - 1 \qquad Equation 17$$

$${\hat{x}}_{p} = {\hat{x}}_{q} / max\_num \_bits \times ( max - min ) + min$$

$$max\_num \_bits = {2}^{bitdepth} - 1 \qquad Equation 18$$

$${\hat{x}}_{p} = \frac{{\hat{x}}_{q}}{max\_num \_bits}$$

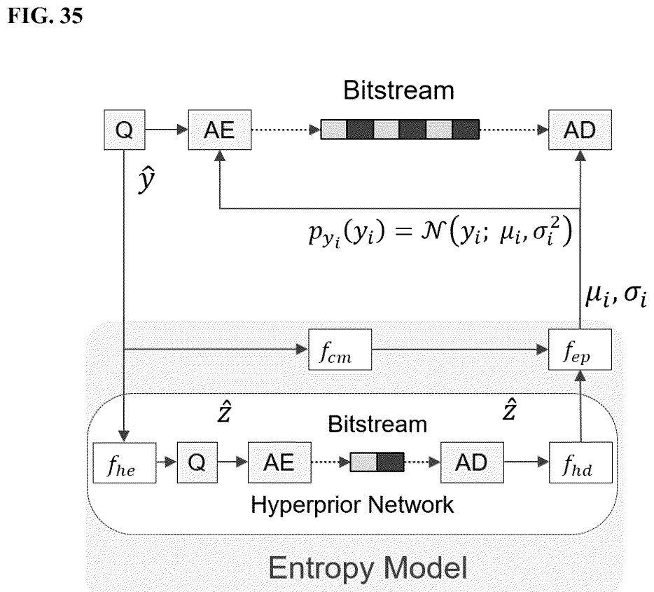

FIG. 35 illustrates an example of neural network-based fused latent representation entropy encoding.

FIG. 35 is an example of neural network-based fused latent representation entropy encoding, which describes the specific example of [D3-3].

Block Q in FIG. 35 performs uniform quantization on all components y of fused latent representation y (in this case, a typical rounding operation may be used), and may output quantized fused latent representation \hat{ }y.

In neural network-based image compression, quantization may be replaced with a process of adding uniform noise between −0.5 and 0.5 at the training time to use a backpropagation algorithm, and a rounding function may be used at the inference time.

In addition, in order to reduce a mismatch between a learning process and an inference process, a rounding function such as is also used in a learning process, in which case an identity function may be used when calculating a gradient for a rounding function.

AE and AD in FIG. 35 represent arithmetic encoding and arithmetic decoding, respectively, and may use range coding other than arithmetic encoding.

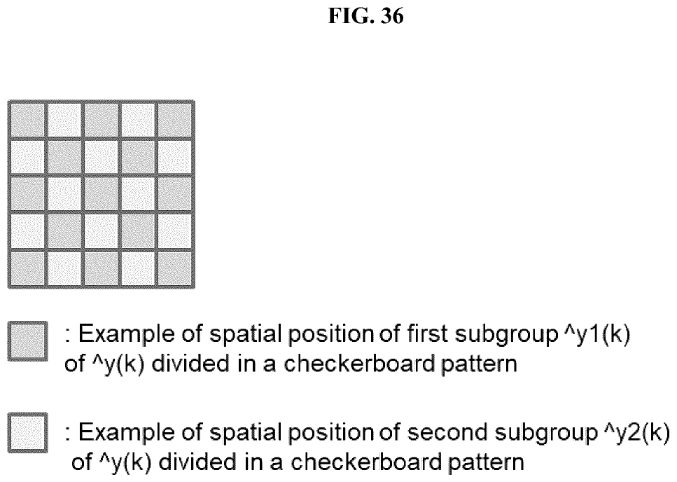

FIG. 36 illustrates an example in which a latent representation group is spatially partitioned into a checkerboard pattern.

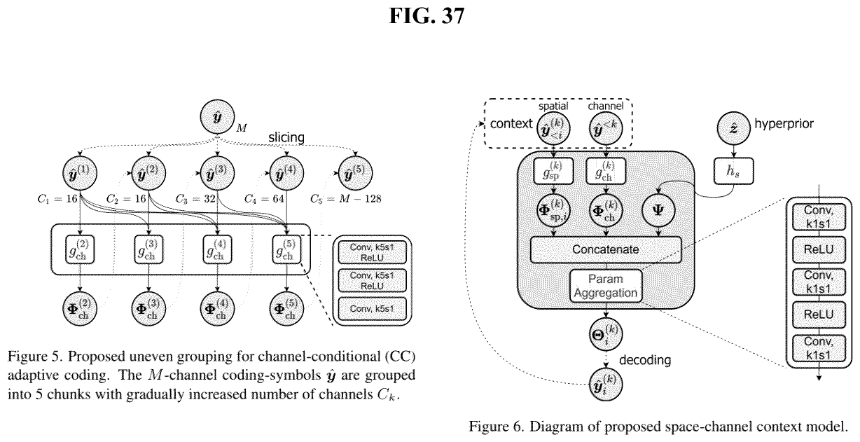

FIG. 37 illustrates an example of a feature map latent representation probability distribution estimation means.

As an example, a feature map latent representation probability distribution estimation means, as in FIG. 5 of FIG. 37, may include a method for additionally utilizing information of already decoded latent representation group \hat{ }y^{(<k)} when sequentially estimating the probability distribution for each latent representation group \hat{ }y^{(k)} after partitioning a latent representation for an image into five groups (\hat{ }y⁽¹⁾, . . . , \hat{ }y⁽⁵⁾) in a non-uniform way in a channel direction. This additional information may be referred to as channel context.

Additionally, as in FIG. 36, each latent representation group \hat{ }y^{(k)} may be spatially partitioned in a checkerboard pattern and divided into two subgroups \hat{ }y₁^{(k)} and \hat{ }y₂^{(k)}, and one subgroup that is already encoded may be utilized as additional information to estimate the probability distribution of the remaining one subgroup. This additional information may be referred to as spatial context.

Finally, a feature map latent representation probability distribution estimation means may partition a latent representation into 10 groups and sequentially perform a total of 10 probability distribution estimations (FIG. 6 of FIG. 37), thereby maximizing the entropy encoding efficiency of a latent representation.

While the embodiments and specific details of the present disclosure are described by using a multi-layer or single-layer feature map as an input/an output, an image, not a feature map, may also be the target of an input/an output.

While the embodiments and specific details of the present disclosure describe latent representation compression for machine vision tasks, they may also be applied to general image reconstruction.

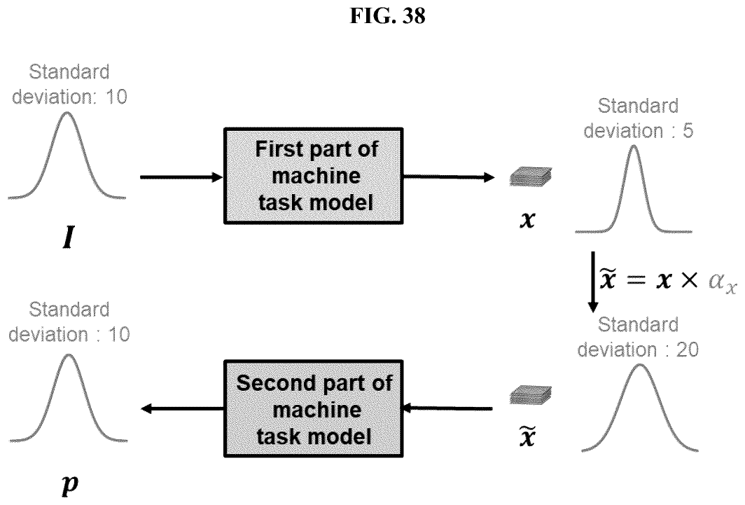

FIG. 38 illustrates an example in which narrowing distribution is compensated through the first part of an artificial neural network-based machine task model and the second part of a machine task model.

The content of the present disclosure described in FIG. 19 relates to expanding the distribution of feature map latent representations to match the distribution of input feature maps and reconstructed feature maps since the distributions of input feature maps, feature map latent representations and reconstructed feature maps gradually narrow through an feature map reconstruction means and a feature map latent representation extraction means based on an artificial neural network.

This content may be expanded to compensate for the narrowing distribution through the first part and the second part of an artificial neural network-based machine task model in the same manner, which is described in FIG. 38.

In other words, the distribution of intermediate feature map x, which is output after the input signal I of the first part of a machine task model passes through the first part of a machine task model, may be narrower than the distribution of input signals, and the distribution of machine task result p, which is output after passing through the second part of a machine task model, may be much narrower. In order to compensate for this distribution change, the distribution of intermediate feature map x may be expanded and used as the input of the second part of a machine task model. In this case, in order to expand the distribution, ax may be used instead of a_{y}, the distribution expansion degree parameter of the present disclosure. In order to obtain aₓ, a method in Embodiment [E3] may be used, and distribution may be expanded through equations shown in Embodiment [D2] (using x instead of y). Here, the output of the second part of a machine task model may be a reconstructed feature map.

Input signal I may have various forms such as an image, a voice, a character string, etc., and machine task result p may be an image, a voice, a character string or machine task performance, etc.

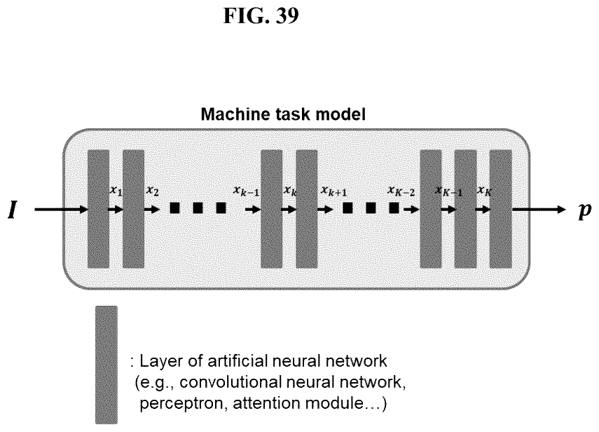

FIG. 39 illustrates an example of a machine task model.

The expansion method of the invention described above may be generalized as in FIG. 39. When intermediate feature maps of multiple layers configuring a machine task model are sequentially referred to as x₁, . . . , xₖ, arbitrary intermediate feature map xⱼ may have a narrower distribution because xᵢ(i<j) is generated through multiple artificial neural network layers. In order to compensate for this, the distribution of xₘ(i≤m<j) may be expanded to ensure that xⱼ has a distribution similar to that of xᵢ.

The present disclosure may perform a method for expanding the distribution through a distribution expansion parameter to solve a problem in which the distribution of output signals may become narrower compared to input signals when an artificial neural network is used.

As the expansion of the present disclosure, instead of a method for matching the distributions of input signals and output signals by using a distribution expansion parameter, a learning method for maintaining the distribution of intermediate feature maps or output signals of an artificial neural network.

The following examples may be used as an example of a learning method for maintaining the distribution.

As an embodiment, the average value and standard deviation of two distributions desired to make similar may be used. In addition to a loss function used when the learning of an artificial neural network, a loss function that makes the average and standard deviation of two distributions equal may be used. When the average of the first distribution of the two distributions is μ₁ and the standard deviation is σ1, and the average of the second distribution is μ₂ and the standard deviation is σ2, a loss function as in Equations 19 to 21 may be used.

Here, two distributions desired to make similar may include the distribution of input signals and output signals, the distribution of input signals and intermediate feature maps, the distribution of intermediate feature maps and the distribution of other intermediate feature maps, the distribution of intermediate feature maps and the distribution of output signals, etc.

In Equations 19, 20 and 21, the value of a weight multiplied by the average and the standard deviation may be adjusted through the values of a and b. For example, when the values of a and b are the same, the same weight may be multiplied by the average and the standard deviation, and the importance of two values may be considered equal. In addition, when one of a and b is used as 0, it may mean that a corresponding index (the average or the standard deviation) is not reflected on a loss function.

the following equation, ∥ ∥ₚ refers to p-norm, and may be

$${‖ x ‖}_{p} = {( {\sum }_{i = 1}^{n} {\vert {x}_{i} \vert}^{p} )}^{\frac{1}{p}} .$$

Alternatively, when two distributions are D₁ and D₂, respectively, an exemplary loss function as in Equation 22 using Kullback-Leibler Divergence (KLD( )) that measures a distance between two distributions may be used, and when it is assumed that two distributions follow Gaussian distribution, it may also be used as in Equation 23.

$${L}_{dis} = a \cdot {‖ {μ}_{1} - {μ}_{2} ‖}_{p} + b \cdot {‖ {σ}_{1} - {σ}_{2} ‖}_{p} \qquad Equation 19$$

$${L}_{dis} = a \cdot {‖ {μ}_{1} - {μ}_{2} ‖}_{p}^{p} + b \cdot {‖ {σ}_{1} - {σ}_{2} ‖}_{p}^{p} \qquad Equation 20$$

$${L}_{dis} = a \cdot {‖ {μ}_{1}^{2} - {μ}_{2}^{2} ‖}_{p}^{p} + b \cdot {‖ {σ}_{1}^{2} - {σ}_{2}^{2} ‖}_{p}^{p} \qquad Equation 21$$

$${L}_{dis} = KLD ( {D}_{1} \vert \vert {D}_{2} ) ) \qquad Equation 22$$

$${L}_{dis} = KLD ( N ( {μ}_{1} , {σ}_{1} ) \vert \vert N ( {μ}_{2} , {σ}_{2} ) ) \qquad Equation 23$$

The exemplary methods of the present disclosure are described as a series of operations for clarity of explanation, but this is not intended to limit the order in which the steps are performed, and when necessary, each step may be performed simultaneously or in a different order. In order to implement a method according to the present disclosure, another step may be additionally included in an exemplary step or the remaining steps may be included excluding some steps or another additional step may be included excluding some steps.

The various embodiments of the present disclosure do not list all possible combinations, but are intended to describe the representative aspect of the present disclosure, and matters described in various embodiments may be applied independently or in a combination of at least two.

In addition, the various embodiments of the present disclosure may be implemented by hardware, firmware, software or a combination thereof. For implementation by hardware, they may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general processors, controllers, microcontrollers, microprocessors, etc.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

1. An image decoding method, the method comprising:
obtaining a reconstructed feature map latent representation by decoding a feature map latent representation obtained by encoding a feature map from a bitstream; and
obtaining a reconstructed feature map by decoding the reconstructed feature map latent representation,
wherein the reconstructed feature map is obtained by performing a distribution expansion based on a distribution expansion parameter obtained from the bitstream, and
wherein the distribution expansion parameter includes a distribution expansion degree parameter.

2. The method of claim 1,
wherein obtaining the reconstructed feature map comprises:
obtaining an intermediate reconstructed feature map by decoding the reconstructed feature map latent representation; and
obtaining the reconstructed feature map by performing the distribution expansion based on the distribution expansion parameter on the intermediate reconstructed feature map.

3. The method of claim 1,
wherein obtaining the reconstructed feature map comprises:
obtaining a distribution-expanded reconstructed feature map latent representation by performing the distribution expansion based on the distribution expansion parameter on the reconstructed feature map latent representation; and
obtaining the reconstructed feature map by decoding the distribution-expanded reconstructed feature map latent representation.

4. The method of claim 3,
wherein the distribution expansion parameter additionally uses at least one of an average of the feature map latent representation and a standard deviation of the feature map latent representation in addition to the distribution expansion degree parameter.

5. The method of claim 4,
wherein the distribution expansion degree parameter has a different value for each channel of the reconstructed feature map latent representation.

6. The method of claim 5,
wherein the average of the feature map latent representation and the standard deviation of the feature map latent representation are obtained by using a channel length of the feature map latent representation.

7. The method of claim 1,
wherein the distribution expansion parameter is determined for each frame I.

8. The method of claim 1,
wherein the distribution expansion parameter is determined for each specific number of frames.

9. The method of claim 1,
wherein learning of the distribution expansion degree parameter is performed simultaneously with learning of a feature map reconstruction means in which obtaining the reconstructed feature map by decoding the reconstructed feature map latent representation is performed.

10. The method of claim 1,
wherein learning of the distribution expansion degree parameter is performed after learning of a feature map reconstruction means is completed in which obtaining the reconstructed feature map by decoding the reconstructed feature map latent representation is performed.

11. The method of claim 1,
wherein obtaining of the reconstructed feature map latent representation is performed by using a standard video compression codec or a neural network-based video compression codec.

12. The method of claim 11,
wherein, in response to the obtaining of the reconstructed feature map latent representation being performed by using the standard video compression codec, the obtaining of the reconstructed feature map latent representation is obtained by performing a latent representation channel rearrangement method.

13. The method of claim 12,
wherein the latent representation channel rearrangement method uses at least one of a channel spatial arrangement, a channel temporal arrangement or a channel spatiotemporal arrangement.

14. The method of claim 13,
wherein a number of horizontal channels and a number of vertical channels used for the channel spatial arrangement are obtained from the bitstream.

15. The method of claim 2,
wherein the distribution expansion parameter additionally uses at least one of an average of the feature map or a standard deviation of the feature map in addition to the distribution expansion degree parameter.

16. The method of claim 15,
wherein the distribution expansion degree parameter has a different value for each channel of the reconstructed feature map.

17. The method of claim 16,
wherein the average of the feature map and the standard deviation of the feature map are obtained by using a channel length of the feature map.

18. The method of claim 1,
wherein learning of the distribution expansion degree parameter is performed by using a distribution of an output signal or an intermediate feature map of an artificial neural network and a distribution of an input signal of the artificial neural network.

19. An image encoding method, the method comprising:
converting a feature map of an input image into a feature map latent representation;
determining, based on the feature map latent representation, a distribution expansion parameter; and
encoding the feature map latent representation and the distribution expansion parameter into a bitstream,
wherein the distribution expansion parameter is used in a process of obtaining a reconstructed feature map by performing a distribution expansion in a decoder, and
wherein the distribution expansion parameter includes a distribution expansion degree parameter.

20. A computer readable recording medium storing a bitstream generated by an image encoding method, wherein the image encoding method comprises:
converting a feature map of an input image into a feature map latent representation;
determining, based on the feature map latent representation, a distribution expansion parameter; and
encoding the feature map latent representation and the distribution expansion parameter into the bitstream,
wherein the distribution expansion parameter is used in a process of obtaining a reconstructed feature map by performing a distribution expansion in a decoder, and
wherein the distribution expansion parameter includes a distribution expansion degree parameter.
